(19) United States
(12) Patent Application Publication
(10) Pub. No.: US 2024/0187434 A1
(43) Pub. Date: Jun. 6, 2024

(54) METHODS AND SYSTEMS FOR DETECTING AND REPORTING ANOMALOUS BEHAVIOR OF OBJECTS RUNNING IN A DATA CENTER

(71) Applicant: VMware LLC, Palo Alto, CA (US)

(72) Inventors: RAJEEV SHASTRI, Bangalore (IN); VALENTIN NACHEV, Sofia (BG); VASUDEV VASHISHT, Bangalore (IN); MOHAMMAD SHAVED, Bangalore (IN); KULDEEP KUMAR, Bangalore (IN); MRITUNJOY SAHA, Bangalore (IN); FILIP DIMITROV, Sofia (BG)

(21) Appl. No.: 18/136,412

(22) Filed: Apr. 19, 2023

(30) Foreign Application Priority Data
Oct. 21, 2022 (IN) 202241060461

(51) Int. Cl. H04L 9/40; H04L 41/16; H04L 41/22

(52) U.S. Cl. CPC H04L 63/1425; H04L 41/16; H04L 41/22

(57) ABSTRACT

This disclosure is directed to automated computer-implemented methods and systems for runtime detection and reporting of anomalous behavior objects running in a data center. A deep neural network is trained to generated forecast metric values of a metric of the object in a time interval from historical metric values of the metric. For each runtime metric value, a runtime residual value is computed based on the runtime metric value and a forecast metric value. Methods and system use spectral residual anomaly detection to determine in real time whether the runtime residual value indicates anomalous behavior of the object. In response to detecting anomalous behavior of the object, methods and system display an alert in a graphical user interface (“GUI”) of an electronic display device. The alert identifies the anomalous behavior of the object, the runtime metric value, and a time stamp of the anomalous behavior.

### RELATED APPLICATION

Benefit is claimed under 35 U.S.C. 119(a)-(d) to Foreign Application Serial No. 202241060461 filed in India entitled “METHODS AND SYSTEMS FOR DETECTING AND REPORTING ANOMALOUS BEHAVIOR OF OBJECTS RUNNING IN A DATA CENTER”, on Oct. 21, 2022 by VMware, Inc., which is herein incorporated in its entirety by reference for all purposes.

### TECHNICAL FIELD

This disclosure is directed to methods and systems for detecting and reporting anomalous behavior in metrics of objects running in a data center.

### BACKGROUND

In recent years, large, distributed computing systems have been built to meet the increasing demand for information technology (“IT”) services. Data centers, for example, execute thousands of applications that enable businesses, governments, and other organizations to offer services over the internet, such as providing business and web services to millions of customers. These organizations cannot afford performance problems that result in downtime or slow execution of their applications. Performance issues frustrate users, damage a brand name, result in lost revenue, and in some cases deny people access to vital services.

To aid system administrators and application owners with detecting anomalous behavior of hardware and applications, various management tools have been developed to collect and record metrics that aid systems administrators and data center tenants in detection of anomalous behavior in objects of a data center. The objects can be virtual objects, such as virtual machines (“VMs”), containers, virtual network devices, applications, and physical objects, such as processors, memory, data storage devices, and network devices. A metric is a time series sequence of values. Each value is a quantitative assessment of a feature of object at a point in time for comparison and performance tracking. Examples of metrics include CPU usage, memory usage, response time, sensor output, and network metrics for tens of thousands of virtual and physical objects running in a data center. Because data center performance issues can be costly for data centers and data center tenants, typical management tools have been equipped with time series anomaly detection to detect anomalies in the collected metrics. Typically, the management tools use one or a combination of conventional approaches to analyzing time series data for anomalous behavior. These approaches include reconstruction-based methods, such as auto encoders, distance-based methods, such as clustering, and conventional forecasting-based methods that are based on autoregression. However, these approaches to anomaly detection are not generally applicable to time series data but are instead limited to time series data that exhibit predictable behavior. For example, conventional forecasting approaches assume that metric values are normally distributed about a mean value. In practice, however, actual metrics are not necessarily normally distributed. Data center metrics are often not distributed according to a known distribution, which limits the reliability of results obtained from applying conventional approaches to data center metrics. Systems administrators and data center tenants seek automated methods and systems that can used for real time anomaly detection in metrics and are not based on any statistical assumptions about the behavior of the metrics.

### SUMMARY

This disclosure is directed to automated computer-implemented methods and systems for runtime detection and reporting of anomalous behavior objects running in a data center. A deep neural network is trained to generated forecast metric values of a metric of the object in a time interval from historical metric values of the metric. For each runtime metric value of the metric generated in the time interval, a runtime residual value is computed based on the runtime metric value and a precomputed forecast metric value at a time stamp of the runtime metric value. Methods and system use spectral residual anomaly detection to determine in real time whether the runtime residual value indicates anomalous behavior of the object. In response to detecting anomalous behavior of the object, methods and system display an alert in a graphical user interface (“GUI”) of an electronic display device. The alert identifies the anomalous behavior of the object, the runtime metric value, and a time stamp of the anomalous behavior.

### DESCRIPTION OF THE DRAWINGS

FIG. 1 shows an architectural diagram for various types of computers.

FIG. 2 shows an Internet-connected distributed computer system.

FIG. 3 shows cloud computing.

FIG. 4 shows generalized hardware and software components of a general-purpose computer system.

FIGS. 5A-5B show two types of virtual machines (“VMs”) and VM execution environments.

FIG. 6 shows an example of an open virtualization format package.

FIG. 7 shows examples of virtual data centers provided as an abstraction of underlying physical-data-center hardware components.

FIG. 8 shows virtual-machine components of a virtual-data-center management server and physical servers of a physical data center.

FIG. 9 shows a cloud-director level of abstraction.

FIG. 10 shows virtual-cloud-connector nodes.

FIG. 11 shows an example server computer used to host three containers.

FIG. 12 shows an approach to implementing containers on a VM.

FIG. 13 shows an example of a virtualization layer 1302 located above a physical data center 1304.

FIG. 14 shows a plot of an example metric. Horizontal axis 1402 represents time.

FIGS. 15A-15B show examples of the operations manager 1332 receiving metrics from various physical and virtual objects.

FIG. 16 shows a plot of an example metric input to a forecast deep neural network (“DNN”) that outputs a forecast metric over a forecast interval.

FIG. 17 shows an architecture of the forecast DNN shown in Figure forecast DNN.

FIG. 18 shows an example of the inputs and outputs of stacks of the

FIGS. 19A shows an example implementation of a block of a stack in the forecast DNN

FIG. 19B shows an example fully-connect stack.

FIG. 20 shows a plot of computing residuals between forecast metric values and the actual metric values.

FIG. 21 shows a plot of residuals for the forecast and actual metrics show in FIG. 20.

FIGS. 22A-22C show example plots of actual and forecast metrics, a saliency map, and anomaly scores over a forecast time interval.

FIG. 23 shows an example graphical user interface (“GUI”) of an operations manager.

FIG. 24 is a flow diagram of a method for detecting and reporting anomalous behavior of an object running in a data center.

FIG. 25 is a flow diagram illustrating an example implementation of the “perform spectral residual anomaly detection to determine whether the runtime residual value indicates anomalous behavior or object” procedure performed in FIG. 24.

### DETAILED DESCRIPTION

This disclosure presents automated computer-implemented methods and systems for detecting and reporting anomalous behavior recorded in metrics of objects executing in a data center. In a first subsection, computer hardware, complex computational systems, and virtualization are described. Computer-implemented methods and systems for detecting and reporting anomalous behavior in metrics of objects executing in a data center are described below in a second subsection.

### Computer Hardware, Complex Computational Systems, and Virtualization

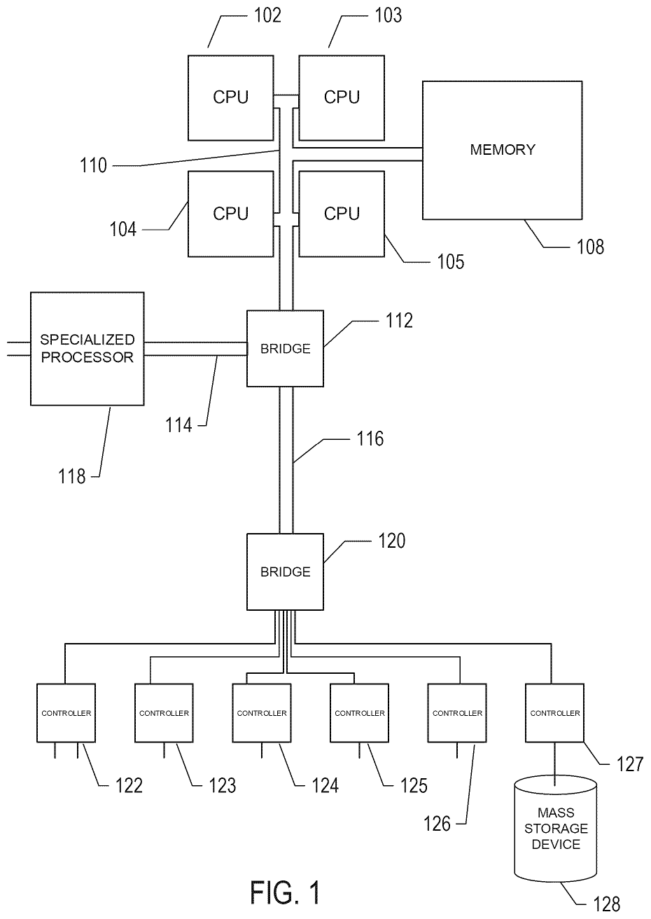

FIG. 1 shows a general architectural diagram for various types of computers. Computers that receive, process, and store log messages may be described by the general architectural diagram shown in FIG. 1, for example. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational devices. It should be noted that computer-readable data-storage devices include optical and electromagnetic disks, electronic memories, and other physical data-storage devices.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of server computers and workstations, and higher-end mainframe computers, but may also include a plethora of various types of special-purpose computing devices, including data-storage systems, communications routers, network nodes, tablet computers, and mobile telephones.

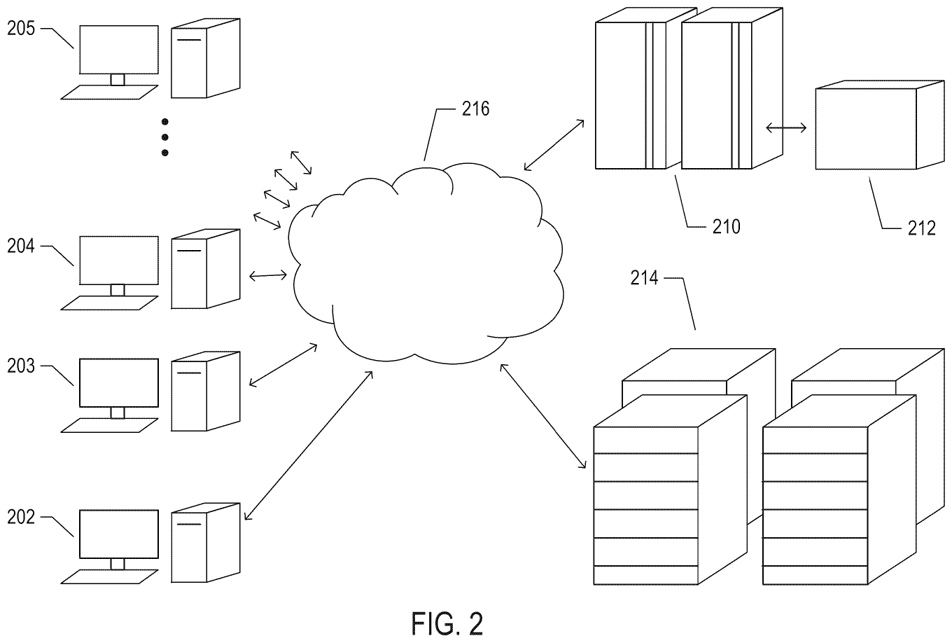

FIG. 2 shows an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted server computers or blade servers all interconnected through various communications and networking systems that together comprise the Internet 216. Such distributed computing systems provide diverse arrays of functionalities. For example, a PC user may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web server computers, back-end computer systems, and data-storage systems for serving web pages to remote customers, receiving orders through the web-page interface, processing the orders, tracking completed orders, and other myriad different tasks associated with an e-commerce enterprise.

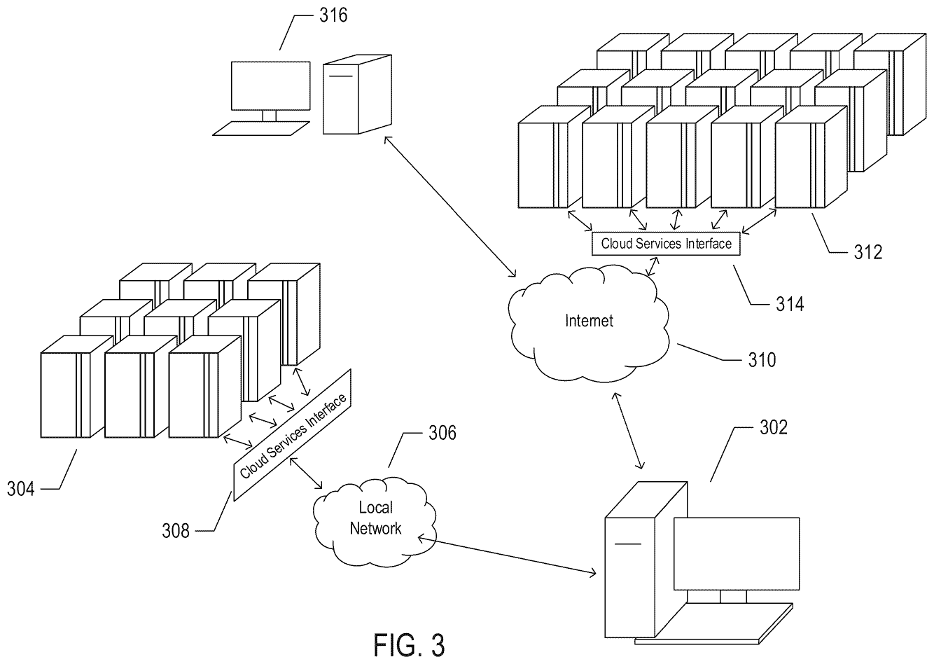

FIG. 3 shows cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the devices to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

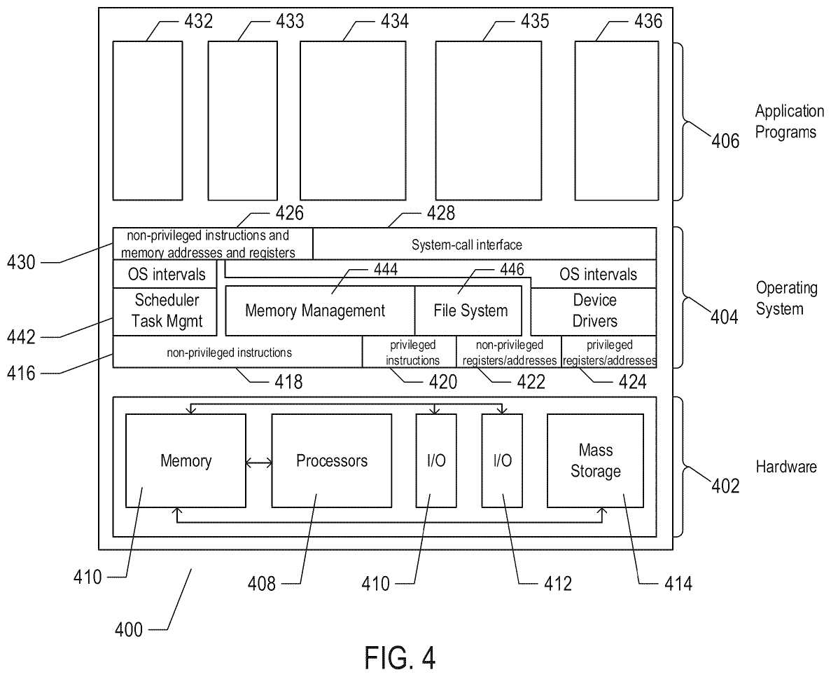

FIG. 4 shows generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor devices and other system devices with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 446 facilitates abstraction of mass-storage-device and memory devices as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

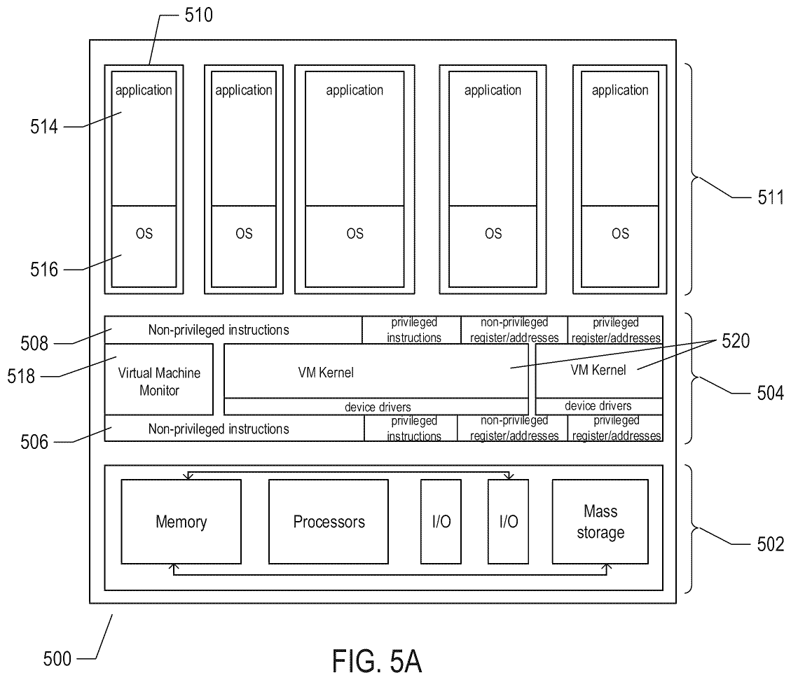

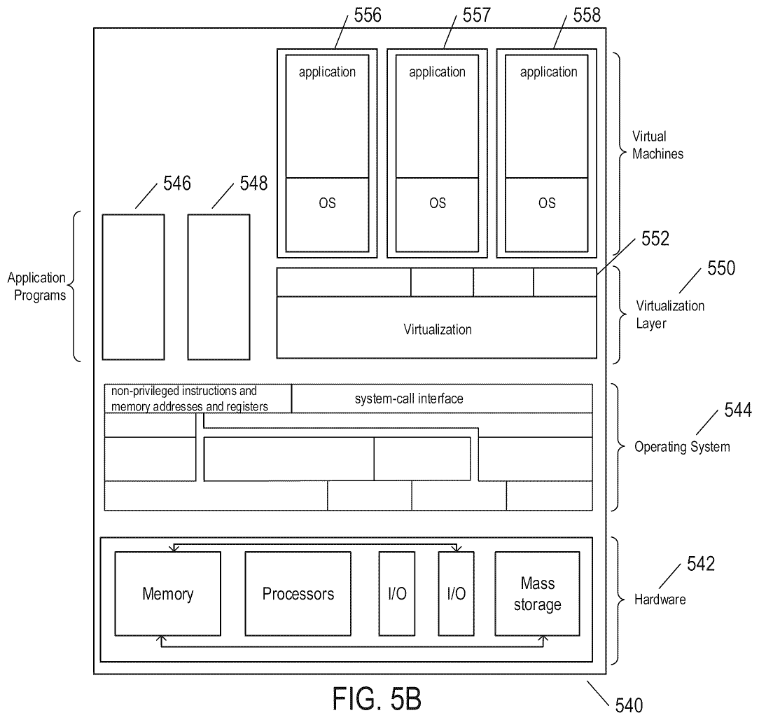

For all of these reasons, a higher level of abstraction, referred to as the “virtual machine,” (“VM”) has been developed and evolved to further abstract computer hardware in order to address many difficulties and challenges associated with traditional computing systems, including the compatibility issues discussed above. FIGS. 5A-B show two types of VM and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment shown in FIG. 5A features a virtualization layer 504 that interfaces through a virtualization-layer/hardware-layer interface 506, equivalent to interface 416 in FIG. 4, to the hardware. The virtualization layer 504 provides a hardware-like interface to VMs, such as VM 510, in a virtual-machine layer 511 executing above the virtualization layer 504. Each VM includes one or more application programs or other higher-level computational entities packaged together with an operating system, referred to as a “guest operating system,” such as application 514 and guest operating system 516 packaged together within VM 510. Each VM is thus equivalent to the operating-system layer 404 and application-program layer 406 in the general-purpose computer system shown in FIG. 4. Each guest operating system within a VM interfaces to the virtualization layer interface 504 rather than to the actual hardware interface 506. The virtualization layer 504 partitions hardware devices into abstract virtual-hardware layers to which each guest operating system within a VM interfaces. The guest operating systems within the VMs, in general, are unaware of the virtualization layer and operate as if they were directly accessing a true hardware interface. The virtualization layer 504 ensures that each of the VMs currently executing within the virtual environment receive a fair allocation of underlying hardware devices and that all VMs receive sufficient devices to progress in execution. The virtualization layer 504 may differ for different guest operating systems. For example, the virtualization layer is generally able to provide virtual hardware interfaces for a variety of different types of computer hardware. This allows, as one example, a VM that includes a guest operating system designed for a particular computer architecture to run on hardware of a different architecture. The number of VMs need not be equal to the number of physical processors or even a multiple of the number of processors.

The virtualization layer 504 includes a virtual-machine-monitor module 518 (“VMM”) that virtualizes physical processors in the hardware layer to create virtual processors on which each of the VMs executes. For execution efficiency, the virtualization layer attempts to allow VMs to directly execute non-privileged instructions and to directly access non-privileged registers and memory. However, when the guest operating system within a VM accesses virtual privileged instructions, virtual privileged registers, and virtual privileged memory through the virtualization layer 504, the accesses result in execution of virtualization-layer code to simulate or emulate the privileged devices. The virtualization layer additionally includes a kernel module 520 that manages memory, communications, and data-storage machine devices on behalf of executing VMs (“VM kernel”). The VM kernel, for example, maintains shadow page tables on each VM so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer 504 essentially schedules execution of VMs much like an operating system schedules execution of application programs, so that the VMs each execute within a complete and fully functional virtual hardware layer.

FIG. 5B shows a second type of virtualization. In FIG. 5B, the computer system 540 includes the same hardware layer 542 and operating system layer 544 as the hardware layer 402 and the operating system layer 404 shown in FIG. 4. Several application programs 546 and 548 are shown running in the execution environment provided by the operating system 544. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The hardware-layer interface 552, equivalent to interface 416 in FIG. 4, provides an execution environment for a number of VMs 556-558, each including one or more application programs or other higher-level computational entities packaged together with a guest operating system.

In FIGS. 5A-5B, the layers are somewhat simplified for clarity of illustration. For example, portions of the virtualization layer 550 may reside within the host- operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

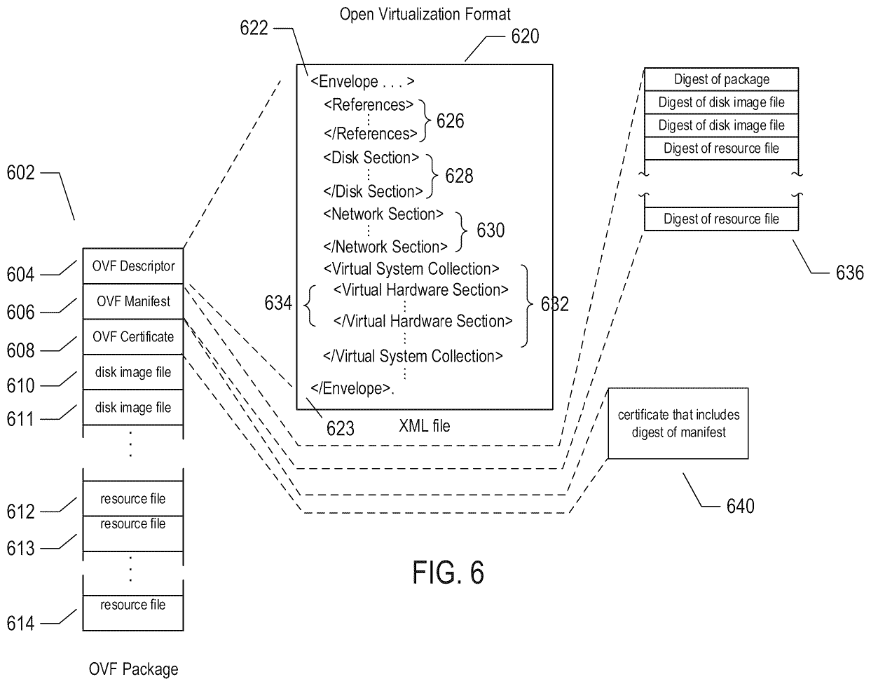

A VM or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a VM within one or more data files. FIG. 6 shows an OVF package. An OVF package 602 includes an OVF descriptor 604, an OVF manifest 606, an OVF certificate 608, one or more disk-image files 610-611, and one or more device files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a network section 630 that includes meta information about all of the logical networks included in the OVF package, and a collection of virtual-machine configurations 632 which further includes hardware descriptions of each VM 634. There are many additional hierarchical levels and elements within a typical OVF descriptor. The OVF descriptor is thus a self-describing, XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and device files 612 are digitally encoded content, such as operating-system images. A VM or a collection of VMs encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more VMs that is encoded within an OVF package.

The advent of VMs and virtual environments has alleviated many of the difficulties and challenges associated with traditional general-purpose computing. Machine and operating-system dependencies can be significantly reduced or eliminated by packaging applications and operating systems together as VMs and virtual appliances that execute within virtual environments provided by virtualization layers running on many different types of computer hardware. A next level of abstraction, referred to as virtual data centers or virtual infrastructure, provide a data-center interface to virtual data centers computationally constructed within physical data centers.

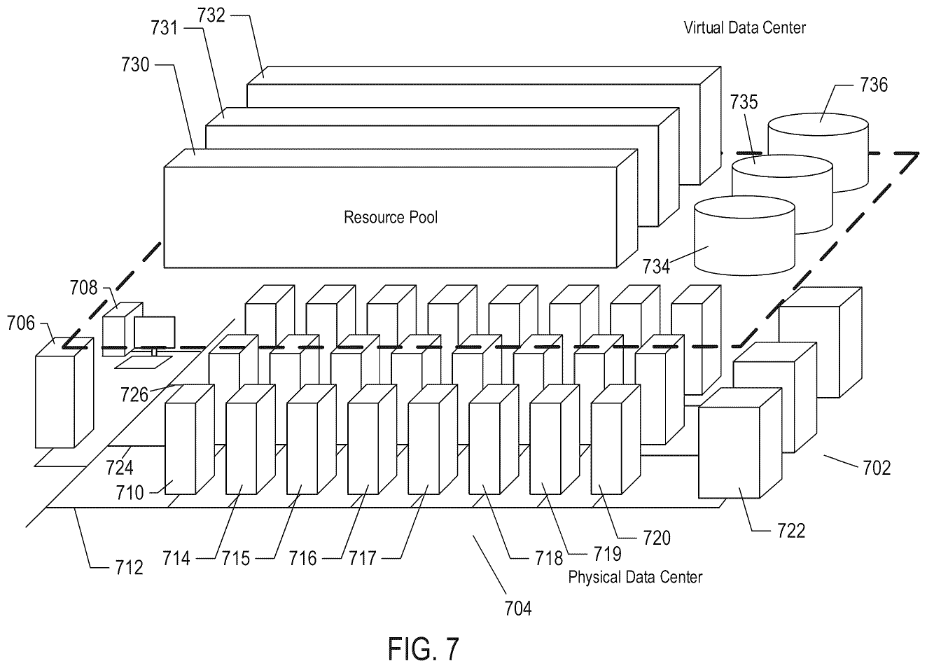

FIG. 7 shows virtual data centers provided as an abstraction of underlying physical-data-center hardware components. In FIG. 7, a physical data center 702 is shown below a virtual-interface plane 704. The physical data center consists of a virtual-data-center management server computer 706 and any of various different computers, such as PC 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight server computers and a mass-storage array. The individual server computers, such as server computer 710, each includes a virtualization layer and runs multiple VMs. Different physical data centers may include many different types of computers, networks, data-storage systems and devices connected according to many different types of connection topologies. The virtual-interface plane 704, a logical abstraction layer shown by a plane in FIG. 7, abstracts the physical data center to a virtual data center comprising one or more device pools, such as device pools 730-732, one or more virtual data stores, such as virtual data stores 734-736, and one or more virtual networks. In certain implementations, the device pools abstract banks of server computers directly interconnected by a local area network.

The virtual-data-center management interface allows provisioning and launching of VMs with respect to device pools, virtual data stores, and virtual networks, so that virtual-data-center administrators need not be concerned with the identities of physical-data-center components used to execute particular VMs. Furthermore, the virtual-data-center management server computer 706 includes functionality to migrate running VMs from one server computer to another in order to optimally or near optimally manage device allocation, provides fault tolerance, and high availability by migrating VMs to most effectively utilize underlying physical hardware devices, to replace VMs disabled by physical hardware problems and failures, and to ensure that multiple VMs supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of VMs and virtual appliances as well as to provide high-level, distributed functionalities that involve pooling the devices of individual server computers and migrating VMs among server computers to achieve load balancing, fault tolerance, and high availability.

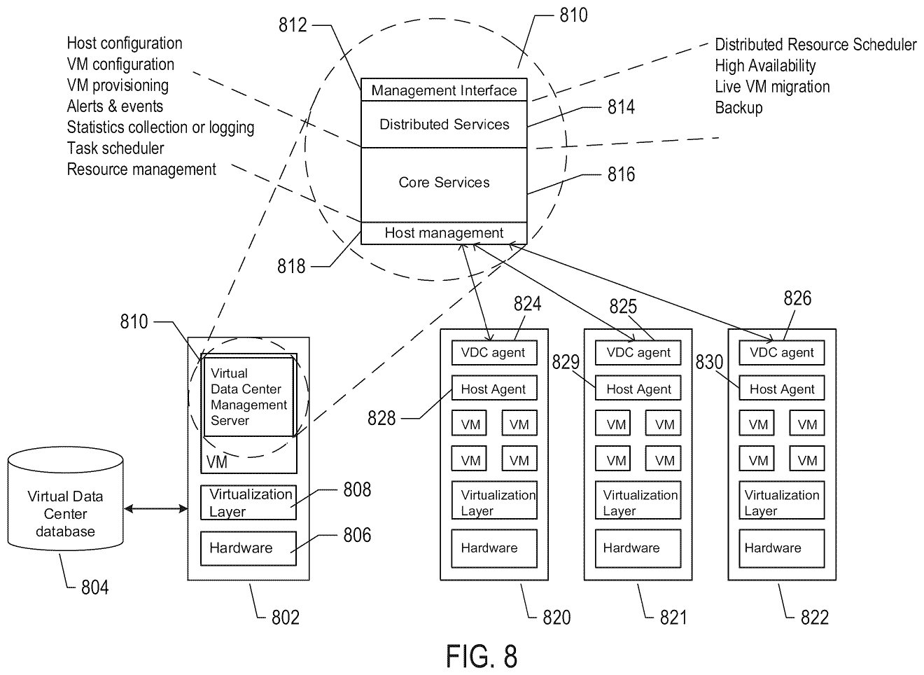

FIG. 8 shows virtual-machine components of a virtual-data-center management server computer and physical server computers of a physical data center above which a virtual-data-center interface is provided by the virtual-data-center management server computer. The virtual-data-center management server computer 802 and a virtual-data-center database 804 comprise the physical components of the management component of the virtual data center. The virtual-data-center management server computer 802 includes a hardware layer 806 and virtualization layer 808 and runs a virtual-data-center management-server VM 810 above the virtualization layer. Although shown as a single server computer in FIG. 8, the virtual-data-center management server computer (“VDC management server”) may include two or more physical server computers that support multiple VDC-management-server virtual appliances. The virtual-data-center management-server VM 810 includes a management-interface component 812, distributed services 814, core services 816, and a host-management interface 818. The host-management interface 818 is accessed from any of various computers, such as the PC 708 shown in FIG. 7. The host-management interface 818 allows the virtual-data-center administrator to configure a virtual data center, provision VMs, collect statistics and view log files for the virtual data center, and to carry out other, similar management tasks. The host-management interface 818 interfaces to virtual-data-center agents 824, 825, and 826 that execute as VMs within each of the server computers of the physical data center that is abstracted to a virtual data center by the VDC management server computer.

The distributed services 814 include a distributed-device scheduler that assigns VMs to execute within particular physical server computers and that migrates VMs in order to most effectively make use of computational bandwidths, data-storage capacities, and network capacities of the physical data center. The distributed services 814 further include a high-availability service that replicates and migrates VMs in order to ensure that VMs continue to execute despite problems and failures experienced by physical hardware components. The distributed services 814 also include a live-virtual-machine migration service that temporarily halts execution of a VM, encapsulates the VM in an OVF package, transmits the OVF package to a different physical server computer, and restarts the VM on the different physical server computer from a virtual-machine state recorded when execution of the VM was halted. The distributed services 814 also include a distributed backup service that provides centralized virtual-machine backup and restore.

The core services 816 provided by the VDC management server VM 810 include host configuration, virtual-machine configuration, virtual-machine provisioning, generation of virtual-data-center alerts and events, ongoing event logging and statistics collection, a task scheduler, and a device-management module. Each physical server computers 820-822 also includes a host-agent VM 828-830 through which the virtualization layer can be accessed via a virtual-infrastructure application programming interface (“API”). This interface allows a remote administrator or user to manage an individual server computer through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server computer. The virtual-data-center agents relay and enforce device allocations made by the VDC management server VM 810, relay virtual-machine provisioning and configuration-change commands to host agents, monitor and collect performance statistics, alerts, and events communicated to the virtual-data-center agents by the local host agents through the interface API, and to carry out other, similar virtual-data-management tasks.

The virtual-data-center abstraction provides a convenient and efficient level of abstraction for exposing the computational devices of a cloud-computing facility to cloud-computing-infrastructure users. A cloud-director management server exposes virtual devices of a cloud-computing facility to cloud-computing-infrastructure users. In addition, the cloud director introduces a multi-tenancy layer of abstraction, which partitions VDCs into tenant-associated VDCs that can each be allocated to an individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

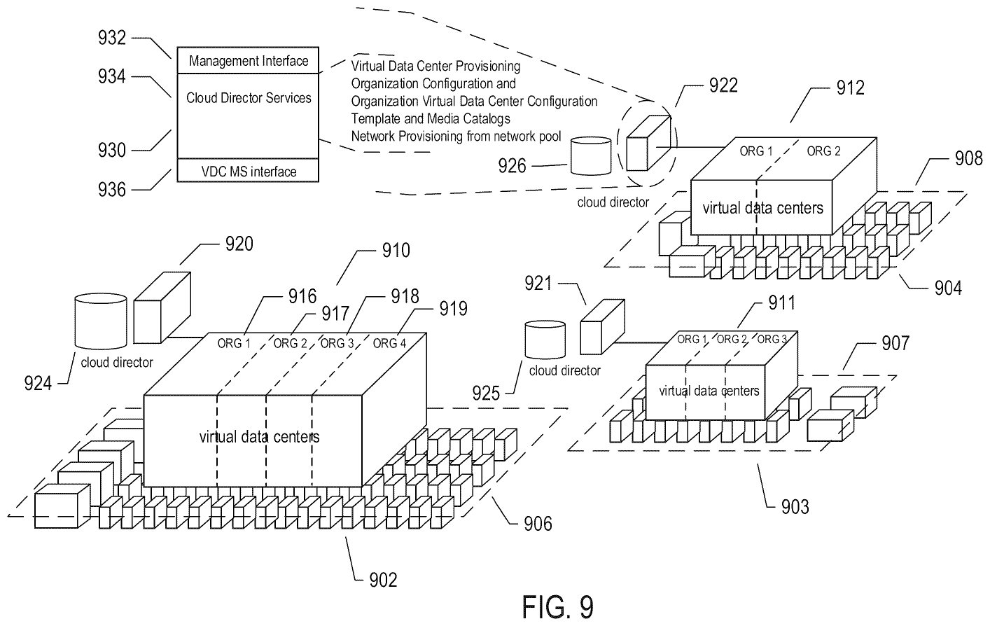

FIG. 9 shows a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The devices of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director server computers 920-922 and associated cloud-director databases 924-926. Each cloud-director server computer or server computers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are VMs that each contains an OS and/or one or more VMs containing applications. A template may include much of the detailed contents of VMs and virtual appliances that are encoded within OVF packages, so that the task of configuring a VM or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VDC-server and cloud-director layers of abstraction can be seen, as discussed above, to facilitate employment of the virtual-data- center concept within private and public clouds. However, this level of abstraction does not fully facilitate aggregation of single-tenant and multi-tenant virtual data centers into heterogeneous or homogeneous aggregations of cloud-computing facilities.

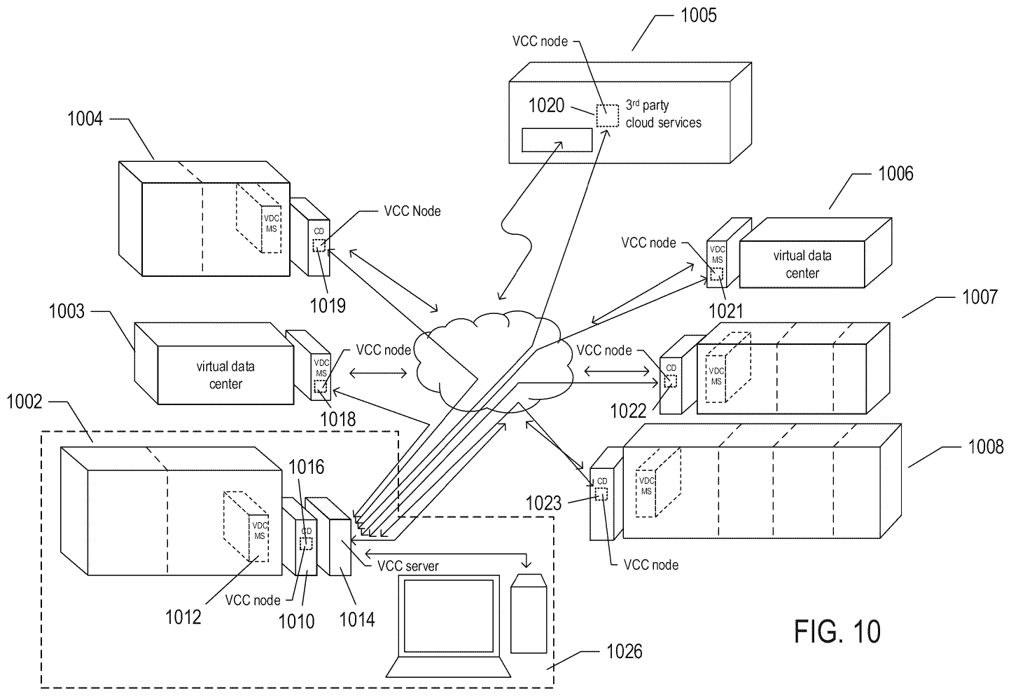

FIG. 10 shows virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloudTM VCC servers and nodes are one example of VCC server and nodes. In FIG. 10, seven different cloud-computing facilities are shown 1002-1008. Cloud-computing facility 1002 is a private multi-tenant cloud with a cloud director 1010 that interfaces to a VDC management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VDC management server that manages a single-tenant private cloud. The VCC server 1014 additionally interfaces, through the Internet, to VCC node virtual appliances executing within remote VDC management servers, remote cloud directors, or within the third-party cloud services 1018-1023. The VCC server provides a VCC server interface that can be displayed on a local or remote terminal, PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

As mentioned above, while the virtual-machine-based virtualization layers, described in the previous subsection, have received widespread adoption and use in a variety of different environments, from personal computers to enormous distributed computing systems, traditional virtualization technologies are associated with computational overheads. While these computational overheads have steadily decreased, over the years, and often represent ten percent or less of the total computational bandwidth consumed by an application running above a guest operating system in a virtualized environment, traditional virtualization technologies nonetheless involve computational costs in return for the power and flexibility that they provide.

While a traditional virtualization layer can simulate the hardware interface expected by any of many different operating systems, OSL virtualization essentially provides a secure partition of the execution environment provided by a particular operating system. As one example, OSL virtualization provides a file system to each container, but the file system provided to the container is essentially a view of a partition of the general file system provided by the underlying operating system of the host. In essence, OSL virtualization uses operating-system features, such as namespace isolation, to isolate each container from the other containers running on the same host. In other words, namespace isolation ensures that each application is executed within the execution environment provided by a container to be isolated from applications executing within the execution environments provided by the other containers. A container cannot access files that are not included in the container's namespace and cannot interact with applications running in other containers. As a result, a container can be booted up much faster than a VM, because the container uses operating-system-kernel features that are already available and functioning within the host. Furthermore, the containers share computational bandwidth, memory, network bandwidth, and other computational resources provided by the operating system, without the overhead associated with computational resources allocated to VMs and virtualization layers. Again, however, OSL virtualization does not provide many desirable features of traditional virtualization. As mentioned above, OSL virtualization does not provide a way to run different types of operating systems for different groups of containers within the same host and OSL-virtualization does not provide for live migration of containers between hosts, high-availability functionality, distributed resource scheduling, and other computational functionality provided by traditional virtualization technologies.

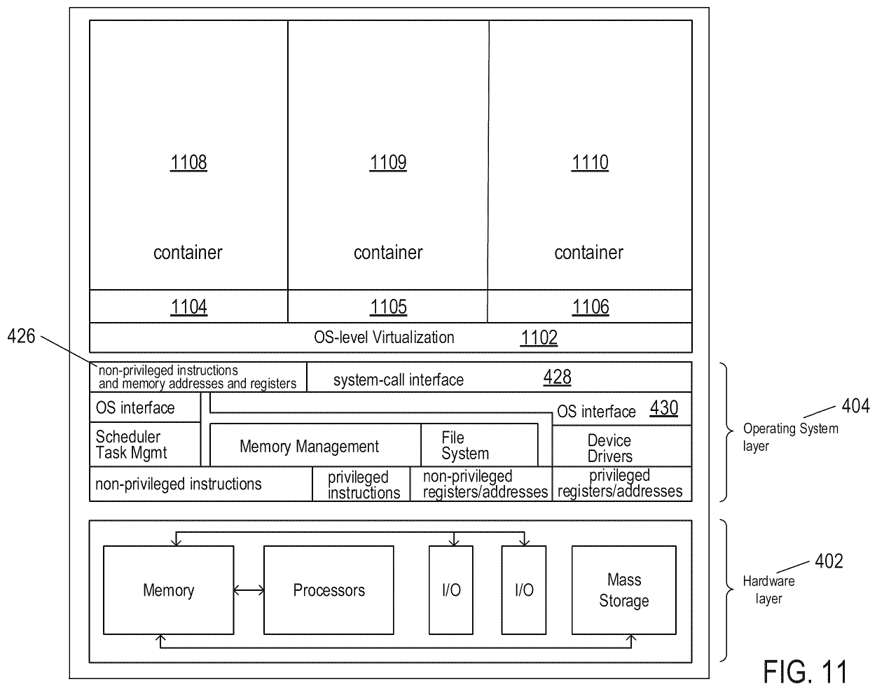

FIG. 11 shows an example server computer used to host three containers. As discussed above with reference to FIG. 4, an operating system layer 404 runs above the hardware 402 of the host computer. The operating system provides an interface, for higher-level computational entities, that includes a system-call interface 428 and the non-privileged instructions, memory addresses, and registers 426 provided by the hardware layer 402. However, unlike in FIG. 4, in which applications run directly above the operating system layer 404, OSL virtualization involves an OSL virtualization layer 1102 that provides operating-system interfaces 1104-1106 to each of the containers 1108-1110. The containers, in turn, provide an execution environment for an application that runs within the execution environment provided by container 1108. The container can be thought of as a partition of the resources generally available to higher-level computational entities through the operating system interface 430.

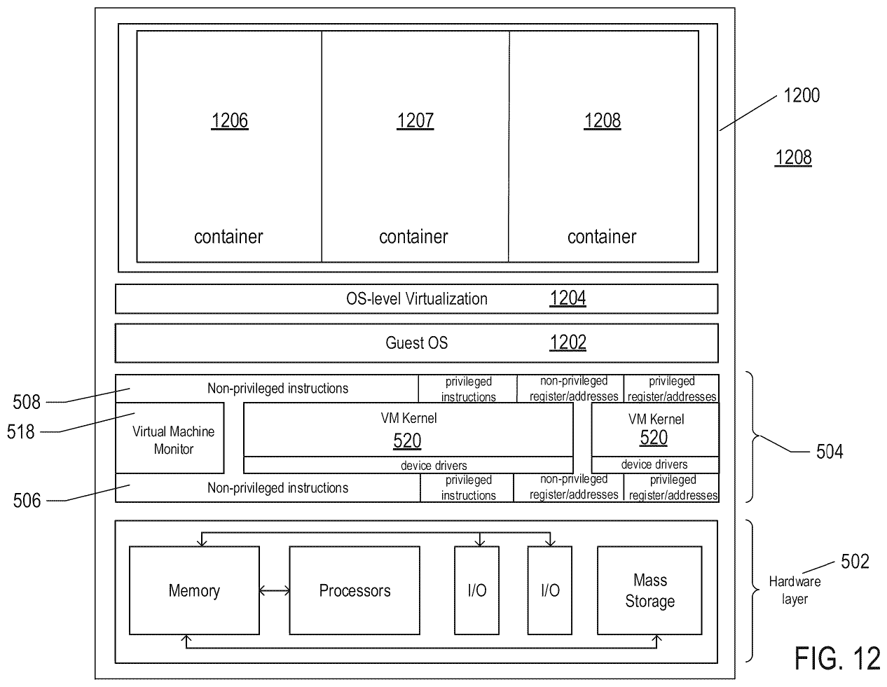

FIG. 12 shows an approach to implementing the containers on a VM. FIG. 12 shows a host computer similar to that shown in FIG. 5A, discussed above. The host computer includes a hardware layer 502 and a virtualization layer 504 that provides a virtual hardware interface 508 to a guest operating system 1102. Unlike in FIG. 5A, the guest operating system interfaces to an OSL-virtualization layer 1104 that provides container execution environments 1206-1208 to multiple application programs.

Note that, although only a single guest operating system and OSL virtualization layer are shown in FIG. 12, a single virtualized host system can run multiple different guest operating systems within multiple VMs, each of which supports one or more OSL-virtualization containers. A virtualized, distributed computing system that uses guest operating systems running within VMs to support OSL-virtualization layers to provide containers for running applications is referred to, in the following discussion, as a “hybrid virtualized distributed computing system.”

Running containers above a guest operating system within a VM provides advantages of traditional virtualization in addition to the advantages of OSL virtualization. Containers can be quickly booted in order to provide additional execution environments and associated resources for additional application instances. The resources available to the guest operating system are efficiently partitioned among the containers provided by the OSL-virtualization layer 1204 in FIG. 12, because there is almost no additional computational overhead associated with container-based partitioning of computational resources. However, many of the powerful and flexible features of the traditional virtualization technology can be applied to VMs in which containers run above guest operating systems, including live migration from one host to another, various types of high-availability and distributed resource scheduling, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides for flexible and scaling over large numbers of hosts within large, distributed computing systems and a simple approach to operating-system upgrades and patches. Thus, the use of OSL virtualization above traditional virtualization in a hybrid virtualized distributed computing system, as shown in FIG. 12, provides many of the advantages of both a traditional virtualization layer and the advantages of OSL virtualization.

### Methods and Systems for Detecting and Reporting Anomalous Behavior Recorded in Metrics of Objects Executing in a Data Center

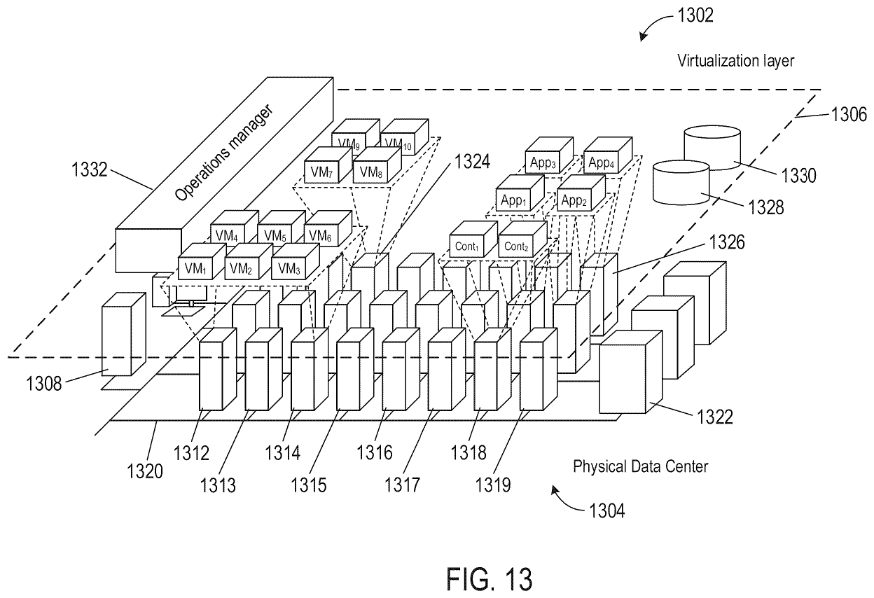

Computer-implemented methods and systems described herein are directed to runtime detection of anomalies in time series data of objects running in a distributed computing system. FIG. 13 shows an example of a virtualization layer 1302 located above a physical data center 1304. For the sake of illustration, the virtualization layer 1302 is separated from the physical data center 1304 by a virtual-interface plane 1306. The physical data center 1304 is an example of a distributed computing system. The physical data center 1304 comprises physical objects, including an administration computer system 1308, any of various computers, such as PC 1310, on which a virtual data center (“VDC”) management interface may be displayed to system administrators and other users, server computers, such as server computers 1312-1319, data-storage devices, and network devices. Each server computer may have multiple network interface cards (“NICs”) that provide high bandwidth and networking to other server computers and data storage devices. The server computers may be networked together to form server-computer groups within the data center 1304. The example physical data center 1304 includes three server-computer groups each of which have eight server computers. For example, server-computer group 1320 comprises interconnected server computers 1312-1319 that are connected to a mass-storage array 1322. Within each server-computer group, certain server computers are grouped together to form a cluster that provides an aggregate set of resources (i.e., resource pool) to objects in the virtualization layer 1302. Different physical data centers may include many different types of computers, networks, data-storage systems, and devices connected according to many different types of connection topologies.

The virtual-interface plane 1306 abstracts the resources of the physical data center 1304 to one or more VDCs comprising the virtual objects and one or more virtual data stores, such as virtual data stores 1328 and 1330. For example, one VDC may comprise the VMs running on server computer 1324 and virtual data store 1328. The virtualization layer 1302 includes virtual objects, such as VMs, applications, and containers, hosted by the server computers in the physical data center 1304. The virtualization layer 1302 may also include a virtual network (not illustrated) of virtual switches, routers, load balancers, and NICs formed from the physical switches, routers, and NICs of the physical data center 1304. Certain server computers host VMs and containers as described above. For example, server computer 1318 hosts two containers identified as Conti and Conte; cluster of server computers 1312-1314 host six VMs identified as VM₁, VM₂, VM₃, VM₄, VM₅, and VM₆; server computer 1324 hosts four VMs identified as VM₇, VM₈, VM₉, VM₁₀. Other server computers may host applications as described above with reference to FIG. 4. For example, server computer 1326 hosts an application identified as App₄.

Computer-implemented methods and systems described herein are executed by an operations manager 1332 that is implemented one or more VMs on the administration computer system 1308. The operations manager 1332 provides several interfaces, such as graphical user interfaces, for data center management, system administrators, and application owners. The operations manager 1332 receives streams of metric data from objects of the data center. An “object” can be a physical object, such as a server computer, a cluster of server computers, and a network device, or a virtual object, such as an application, VM, virtual network device, or a container.

Each stream of metric data is time-series data that is generated by an event source of an object, such as an operating system, a resource, or by an object itself. A stream of metric data is a sequence of time-ordered metric values that are recorded in a data storage device in spaced points in time called “time stamps.” A stream of metric data is simply called a “metric” and is denoted by where

[symbol]

=(zᵢ)ᵢ₌₁^{N}=(z(tᵢ))ᵢ₌₁^{N} (1)

where
N is the number of metric values in a sequence of metric values;
zᵢ=z(tᵢ) is a metric value;
t 1 is a time stamp indicating when the metric value was generated in a time interval [t₁, t_{N}];
[symbol] = [symbol] ^{N}; and
subscript i is a time stamp index i=1, . . . ,N.

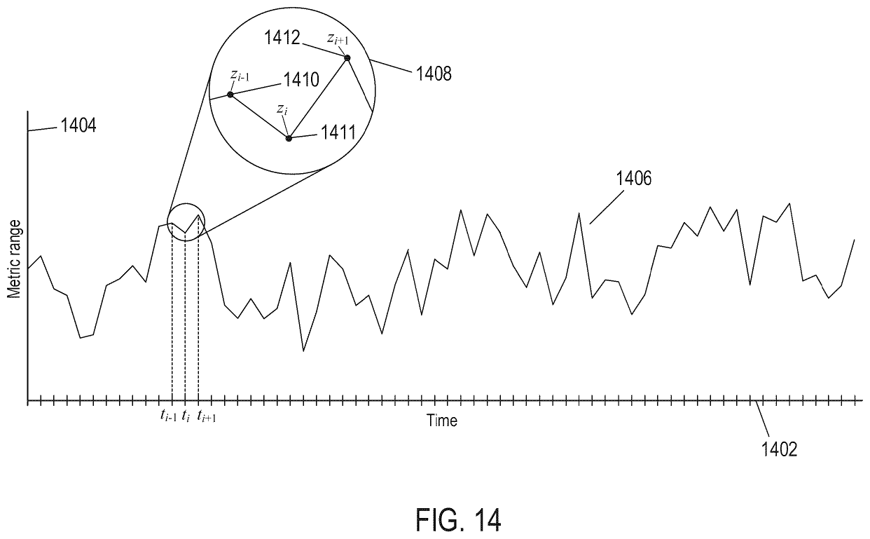

FIG. 14 shows a plot of an example metric. Horizontal axis 1402 represents time. Vertical axis 1404 represents a range of metric values. Curve 1406 represents a metric as time-series data. FIG. 14 includes a magnified view 1408 of three consecutive metric values represented by points. Each point represents an amplitude of the metric at a corresponding time stamp. For example, points 1410-1412 represent consecutive metric values (i.e., amplitudes) zᵢ₋₁, zᵢ, and zᵢ₊₁ recorded in a data-storage device at corresponding time stamps tᵢ₋₁, tᵢ, and tᵢ₊₁. The example metric may represent usage of a physical or virtual resource. For example, the metric may represent CPU usage of a core in a multicore processor of a server computer over time. The metric may represent the amount of virtual memory assigned to a VM over time. The metric may represent network throughput for a server computer. The metric may also represent object performance, such as CPU contention, response time to requests, and wait time for access to a resource of an object. The metric may also represent network flows, or simply net flows, used to monitor network traffic flow. Network flows include percentage of packets dropped, data transmission rate, data receiver rate, and total throughput.

Data center tenants and system administrators also rely on key performance indicators (“KPIs”) to monitor the overall health and performance of applications and objects executing in a data center. A KPI is a health metric constructed from other metrics. Certain KPIs that do not depend on other metrics can be used to monitor performance of applications. For example, a KPI for an online shopping application could be the number of shopping carts successfully closed per unit time. A KPI for a website may be response times to customer requests. Other KPIs can be used to monitor performance of various services provided by different components of a distributed application. Consider, for example, a distributed application that provides banking services via a bank website or a mobile application (“mobile app”). One component provides front-end services that enable users to input banking requests and receive responses to requests via the website or the mobile app. Other components of the distributed application provide back-end services that are executed in VMs running on hosts of the data center. These services include processing user banking requests, maintaining data storage, and retrieving user information from data storage. Each of these services can be monitored with an error rate KPI and a time span KPI.

A distributed resource scheduling (“DRS”) score is an example of a that is constructed from other metrics and is used to measure efficient use of resources (e.g., CPU, memory, and network) by an object and is computed as a product of efficiencies as follows:

$$z ( t ) = {EFFCY}_{CPU} ( t ) \times {EFFCY}_{Mem} ( t ) \times {EFFCY}_{Net} ( t ) \qquad ( 2 )$$

$$where$$

$${EFFCY}_{CPU} ( t ) = \frac{C P U usage ( t )}{Ideal C P U usage} ;$$

$${EFFCY}_{Mem} ( t ) = \frac{Memory usage ( t )}{Ideal Memory usage} ;$$

$$and$$

$${EFFCY}_{Net} ( t ) = \frac{Network throughput ( t )}{Ideal Network throughput}$$

The metrics CPU usage (t), Memory usag 4), and Network throughput(t) of an object are measured at points in time as described above with reference to Equation (2). Ideal CPU usage, Ideal Memory usage, and Ideal Network throughput are preset, For example. Ideal CPU usage may be preset to 30% of the CPU and Ideal Memory usage may , be preset to 40% of the memory. DRS scores can be used for, example, as a KPI that measures the overall health of a distributed application by aggregating, or averaging, the DRS scores of each VM or container that executes a component of the distributed application.

Other examples of KPIs include average response times to client request, error rates, contention time for resources, or a peak response time. Other types of KPIs can be used to measure the performance level of a cloud application. A cloud application is a distributed application with data storage and logical components of the application executed in a data center and local components provide access to the application over the internet via a web browser or a mobile application on a mobile device. For example, a KPI for an online shopping application could be the number of shopping carts successfully closed per unit time. A KPI for a website may be response times to customer requests. KPIs may also include latency in data transfer, throughput number of packets dropped per unit time, or number of packets transmitted per unit time.

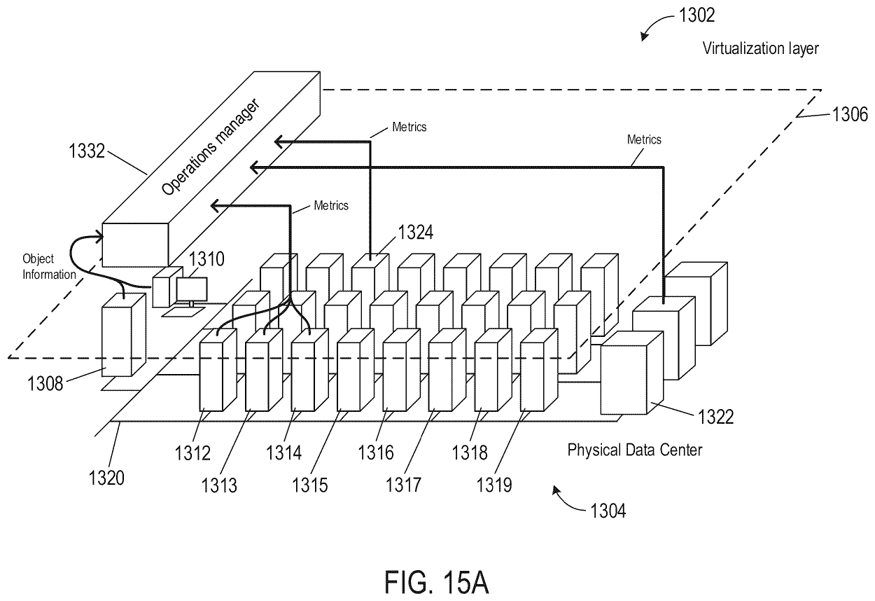

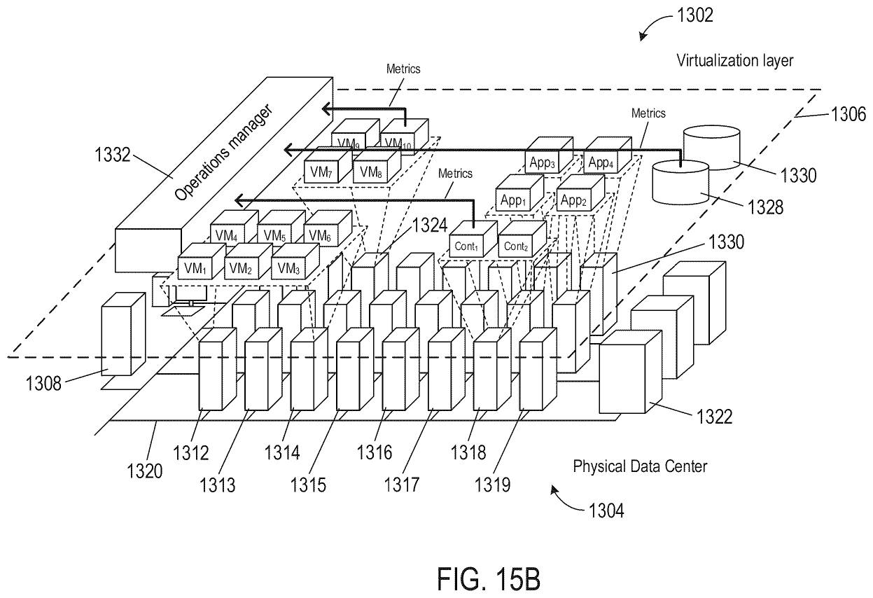

FIGS. 15A-15B show examples of the operations manager 1332 receiving metrics from various physical and virtual objects of the data center shown in FIG. 13. Directional arrows represent object information sent from physical and virtual resources to the operations manager 1332. In FIG. 15A, the operating systems of PC 1310, server computers 1308 and 1324, and mass-storage array 1322 send metrics to the operations manager 1332. A cluster of server computers 1312-1314 send metrics to the operations manager 1332. In FIG. 15B, the VMs, containers, applications, and virtual storage may independently send metrics to the operations manager 1332. Certain objects send metrics as the metric values are generated while other objects may only send metric values at certain times or when requested to send the metrics by the operations manager 1332. The operations manager 1332 collects and processes the metrics as described below to detect runtime anomalous behavior of objects. When an object exhibiting anomalous behavior is detected, the anomalous behavior is reported in graphical user interface of visual display device, thereby enable system administrators to immediately execute remedial measures. Remedial measures include, but are not limited to, reconfiguring a virtual network of a VDC, migrating VMs from one server computer to another, restarting server computers, replacing VMs disabled by physical hardware problems and failures, spinning up cloned VMs on additional server computers to ensure that services are available to increasing demand or when one or more of the VMs fail to run.

Data center management tools have been developed to monitor the performance of applications and objects executing in a data center. These management tools collect metrics to monitor performance of data center resources and perform time series anomaly detection with forecast models that are constructed from historical time series data using a forecasting method. The forecast models are used to predict metric values over a time interval. The error between the predicted values and actual values arising in the time interval is compared to a threshold error. The error can be mean squared error (“MSE”), interquartile range (“IQR”) or percentile confidence bounds. Typical forecasting methods based on this approach include autoregressive (“AR”), moving average (“MA”), autoregressive moving average (“ARMA”), autoregressive integrated moving average (“ARIMA”), seasonal ARIMA (“SARIMA”), and deep neural network (“DNN”) based methods such as long-short term memory network (“LSTM”), and convolutional neural network (“CNN”). The forecast models are constructed by partitioning historical time series data into a training set and a testing set. Parameters of the forecast models are learned based on the training set and are used to predict metric values based on the testing subset. The predicted metric values are aligned with the metric values of the test set to identify deviations and correct the forecast models. Anomalies in metrics can be classified into point anomalies (a metric value deviating from the rest of the metric data), collective anomalies (pattern or a sequence is an anomaly) and contextual anomalies (doesn't represent the sample behavior).

The time series defined in AR, MA, and ARMA models are stationary, which means that the average of the time series and the covariance do not change with time. For non-stationary time series, the transformation of the series to a stationary series must be performed first. On the other hand, the ARIMA model fits the non-stationary time series, with a differencing process that effectively transforms the non-stationary data into a stationary one. SARIMA models, which combine seasonal differencing with an ARIMA model, are used when the time series data exhibits periodic characteristics. However, the assumptions underlying the ARMA, ARIMA, and SARIMA methods for forecasting are not practical for many types of data center metrics. Data center metrics are typically not stationary and not normally distributed. As a result, these models perform poorly with metrics that do not fit the underlying assumption of being normally distributed.

Computer-implemented methods and systems described herein are directed to a forecast deep neural network (“DNN”) architecture composed of backward and forward residual links stacked with fully connected layers working as an ensemble at the end of a network for forecasting metric values of a metric. The methods and systems compute residuals between the forecast metric values and actual metric values. Spectral residual (“SR”) method is applied to the residuals to detect anomalous metric values. The novelty lies in using the forecast DNN to forecast metric values followed by using SR method to detect anomalous metric values.

The metric [symbol] may have metric values that are much larger relative to the other metric values. These large values can dominate or skew typical machine learning algorithms toward the larger values. To avoid large metric values, the time series [symbol] is scaled to a normal range. In one implementation, each metric value in the metric [symbol] is scaled using min-max scaling:

$${y}_{i} = \frac{{z}_{i} - min}{max - min} \qquad ( 2 a )$$

$$where$$

$$min = min \{ {z}_{1} , … , {z}_{N} \} ;$$

$$and$$

$$max = max \{ {z}_{1} , … , {z}_{N} \} .$$

In another implementation, each metric value in the metric [symbol] is scaled using robust scaling:

$${y}_{i} = \frac{{z}_{i} - med}{IQR} \qquad ( 2 b )$$

where
   med =median{z₁, . . . , z_{N}}; and
   IQR is the interquartile range of the time series.
      The sequence of metric values that have been scaled in the time interval [t₁, t_{N}] are denoted by [symbol] =(yᵢ)ᵢ₌₁^{N}=(y(tᵢ))ᵢ₌₁^{N} with [symbol] = [symbol] ^{N}. The metric values [symbol] are input to a forecast DNN to generate a sequence of forecast metric values denoted by ŷ=(ŷᵢ)_{i=N+1}^{N+H}=(ŷ(tᵢ))_{i=N+1}^{N+H}, with ŷ= [symbol] ^{H}, in a forecast time interval [t_{N+1}, t_{N+H+1}]. The forecast metric values ŷ are a prediction of scaled actual metric values denoted by [symbol] =(yᵢ)_{i=N+1}^{N+H}=(y(tᵢ))_{i=N+1}^{N+H} associated with the object in the forecast time interval [t_{N+1}, t_{N+H}].

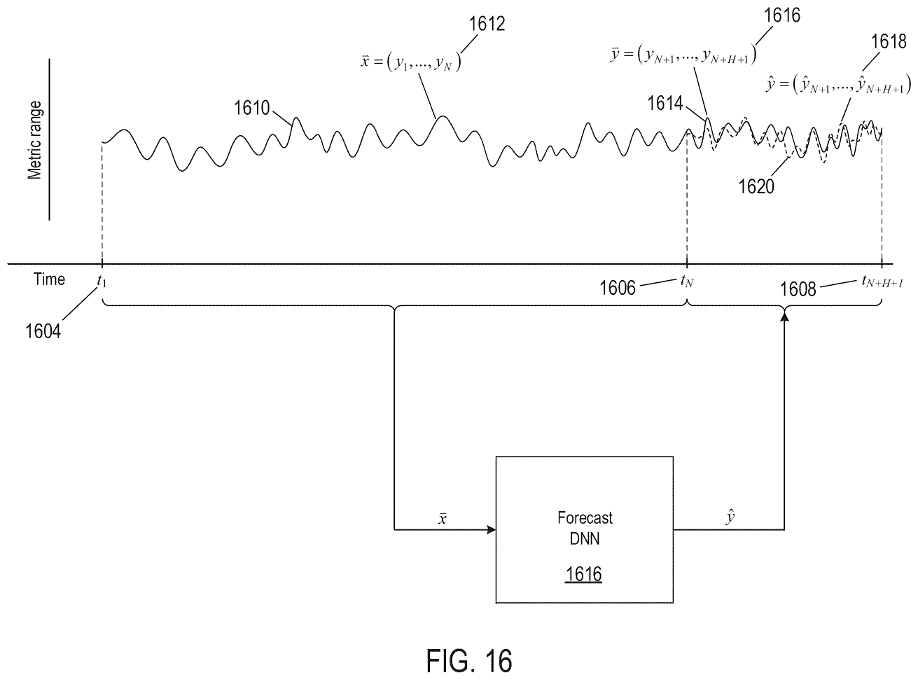

FIG. 16 shows a plot of an example metric that is input to a forecast DNN that in turn outputs a forecast metric over a time interval. Horizontal line 1602 is a time axis with endpoints 1604 and 1606 of a historical time interval [t₁, t_{N}] and an endpoint 1608 of a time interval [t_{N+1}, t_{N+H}]. Solid curve 1610 represents the scaled metric values [symbol] 1612 generated an event source of an object in the historical time interval [t₁, t_{N}]. Solid curve 1614 represents metrics values [symbol] 1616 generated by the event source of the object in the time interval [t_{N+1}, t_{N+H}]. Block 1616 represents the forecast DNN that receives the metric values [symbol] 1610 as input and outputs forecast metric values ŷ 1618 in the time interval [t_{N+1}, t_{N+H}]. Dashed curve 1620 represents the forecast metric values ŷ 1618.

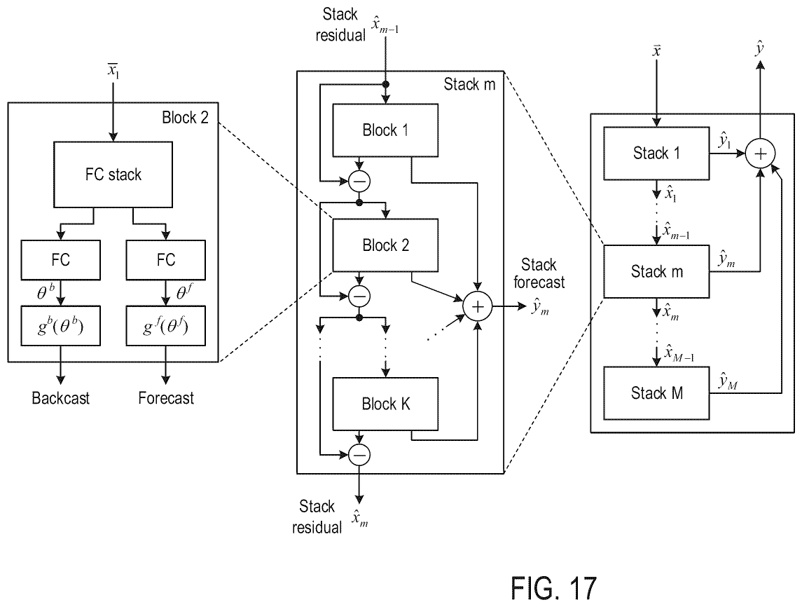

FIG. 17 shows an architecture of the forecast DNN 1616. The forecast DNN 1616 comprises a series of M stacks denoted by Stack 1, . . . , Stack M. Each stack comprises a series of K blocks denoted by Block 1, . . . , Block K. The metric values [symbol] are input to the first Stack 1. Each of the stacks Stack 1, . . . , Stack M−1 outputs a stack residual denoted by \hat{x}ₘ and outputs a stack forecast ŷₘ. The Stack m receives as input a residual \hat{x}ₘ₋₁ from preceding Stack m−1 (not shown) and outputs a residual \hat{x}ₘ that is input to subsequent Stack m+1 (not shown). Note that the Stack M only outputs a stack forecast ŷ_{M}. The stack forecasts ŷ₁, . . . , ŷ_{M} are summed to obtain the forecast metric:

$$\hat{y} = {\sum }_{m = 1}^{M} {\hat{y}}_{m} \\ where {\hat{y}}_{m} = ( {\hat{y}}_{m , N + 1} , … , {\hat{y}}_{m , N + H + 1} ) . \qquad ( 3 )$$

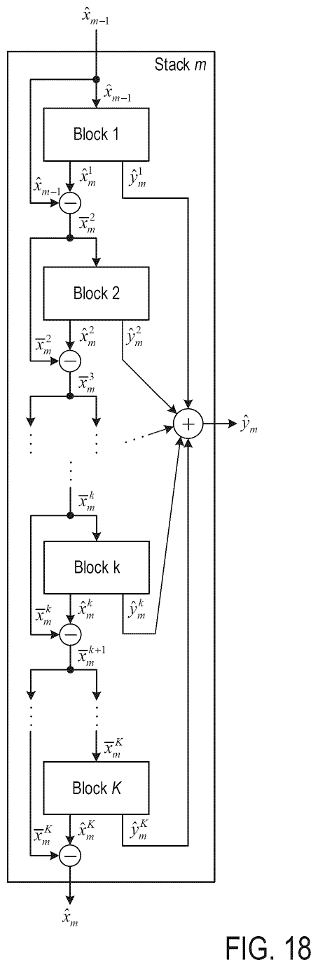

FIG. 18 shows an example of the inputs and outputs of the blocks in the Stack 1 of the forecast DNN 1616. Each block outputs a backcast denoted by \hat{x}ₘ^{k} and a forecast denoted by ŷₘ^{k}, where subscript m is a stack index m=1, . . . , M and superscript k is a block index k=1, . . . , K. Block 1 receives as input residual \hat{x}ₘ 1804 of Stack m−1 and outputs a backcast \hat{x}ₘ¹ and a forecast ŷₘ¹. At subtraction junction 1806 a block residual is calculated, x̅ₘ²=\hat{x}ₘ₋₁−\hat{x}ₘ¹, and input to Block 2, where superscript 2 denotes input to Block 2. In general, the residual input to a Block k is given by x̅ₘ^{k}=x̅ₘ^{k-1}−\hat{x}ₘ^{k-1}, where \hat{x}ₘ^{k-1} is the backcast output from preceding Block k−1 (not shown) and x̅ₘ^{k} is the block residual input to preceding Block k−1. Block k outputs a backcast \hat{x}ₘ^{k} and a forecast ŷₘ^{k}.The residual input to Block k+1 (not shown) is given by x̅ₘ^{k}=x̅ₘ^{k}−\hat{x}ₘ^{k}. The block residual for the final Block K in the Stack in is the stack residual given by \hat{x}ₘ=x̅ₘ^{K}−\hat{x}ₘ^{K}. The forecast output from each block is summed to obtain the Stack in forecast:

$${\hat{y}}_{m} = {\sum }_{k = 1}^{K} {\hat{y}}_{m}^{k} \qquad ( 4 )$$

Each block is implemented as a DNN based on backward and forward residual links. The DNN is a deep stack of fully connected (“FC”) layers.

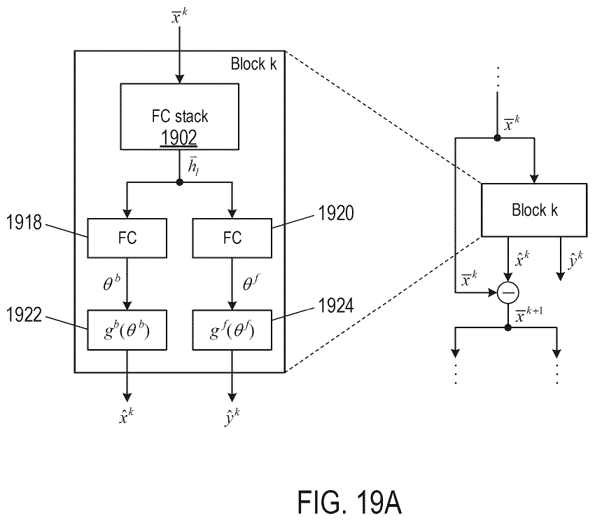

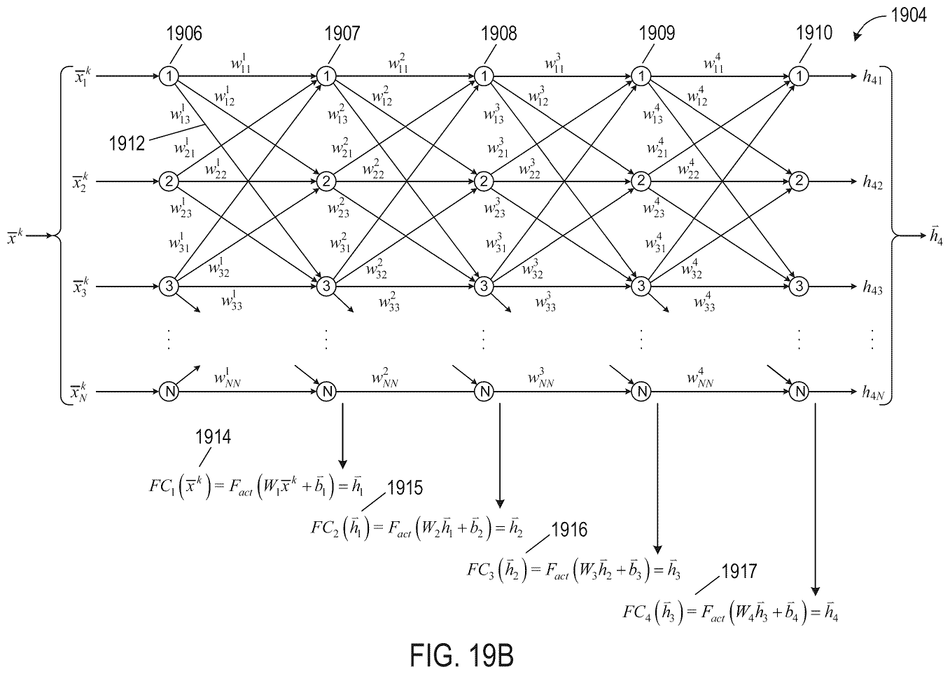

FIGS. 19A shows an example implementation of a block k that receives as input the residual x̅^{k} described above with reference to FIG. 18 and outputs a backcast \hat{x}^{k} and a forecast ji k . Block k represents a block in one of the stacks Stack rn, where m=1, . . . , M. For the sake of clarity in the following discussion, the stack index in is omitted. The block k executes an FC stack 1902 that receives the residual) x̅^{k} and generates an output [symbol] , where subscript l denotes the number of FC layers in the FC stack 1902.

FIG. 19B shows an example FC stack 1904 with four FC layers. The FC stack 1904 includes an input layer 1906 and four FC hidden layers 1907-1910. Each layer comprises a column of N nodes represented by circles. Each node of the input layer 1906 corresponds to a value x̅ᵢ^{k} in the residual x̅^{k}=(x̅ᵢ^{k})ᵢ₌₁^{N}. For example, node 1908 represents the value x̅₁^{k} 1910. Directional arrows represent connections between nodes in adjacent layers. In FC layers, each node is connected to all of the nodes in the adjacent layer. For example, direction arrows connect node 1 in the input layer 1906 to each of the nodes in the adjacent hidden layer 1907. Note that for the sake illustration, only the connections from the node 1 in the input payer 1906 to the nodes 1, 2, and 3 of the hidden layer 1907 are shown. Similar connections between the node 1 and the nodes 4 to node N of the hidden layer 1907 are not shown. Each connection represents a weight denoted by wᵣₛ^{q}, where superscript q denotes connections from q layer, subscript r is node index in the q layer, and subscript s denotes the node index in the adjacent layer. The value of a weight represents the strength of a connection between two nodes in adjacent layers. For example, weight w₁₃¹ represents the weight (i.e., strength) of the connection 1912 between the node 1 of the input layer 1906 and node 3 of the hidden layer 1907. The nodes at the first hidden layer 1907 represent computational operations:

$${h}_{1 j} = {F}_{act} ( {\sum }_{i = 1}^{N} {w}_{ij}^{1} {\overline{x}}_{i}^{k} + {b}_{1 j} ) \qquad ( 5 a )$$

where
   j=1, . . . , N;
   F_{act} denotes an activation function;
   h₁ⱼ denotes the output of the j-th node in the hidden layer 1907; and
   b₁ⱼ denotes a bias variable (e.g., 0 or 1).
      The activation function F_{act} can be, for example, the rectified linear unit function (“ReLu”), the sigmoid function, or the arc tangent function. The output of the N nodes in the first hidden layer 1907 is denoted by a sequence [symbol] ₁=(h₁ⱼ)ⱼ₌₁^{N}. The nodes in the second hidden layer 1908 represent computational operations:

$${h}_{2 j} = {F}_{act} ( {\sum }_{i = 1}^{N} {w}_{ij}^{2} {h}_{1 i} + {b}_{2 j} ) \qquad ( 5 b )$$

The value h₂ⱼ is the output from the j-th node in the second hidden layer 1908. The output of the N nodes in the second hidden layer 1908 is denoted by a sequence [symbol] ₂=(h₂ⱼ)ⱼ₌₁^{N}. The nodes in the third hidden layer 1909 represent computational operations:

$${h}_{3 j} = {F}_{act} ( {\sum }_{i = 1}^{N} {w}_{ij}^{3} {h}_{2 i} + {b}_{3 j} ) \qquad ( 5 c )$$

The value h₃ⱼ is output from the j-th node of the third hidden layer 1909. The output of the N nodes in the third hidden layer 1909 is denoted by [symbol] ₃=(h₃ⱼ)ⱼ₌₁^{N}. The nodes in the fourth hidden layer 1910 represent computational operations:

$${h}_{4 j} = {F}_{act} ( {\sum }_{i = 1}^{N} {w}_{ij}^{4} {h}_{3 i} + {b}_{4 j} ) \qquad ( 5 d )$$

The value h₄ⱼ is output of j-th node of the fourth hidden layer 1910. The output of the N nodes in the fourth hidden layer 1910 is denoted by [symbol] ₁=(h₄ⱼ)ⱼ₌₁^{N}.

The weights connecting nodes between the q-th layer and the adjacent layer can be represented in matrix notation:

$${W}_{q} = [ \begin{matrix}{w}_{11}^{q} & {w}_{21}^{q} & {w}_{31}^{q} & … & {w}_{N 1}^{q} \\ {w}_{12}^{q} & {w}_{22}^{q} & {w}_{32}^{q} & … & {w}_{N 2}^{q} \\ {w}_{13}^{q} & {w}_{23}^{q} & {w}_{33}^{q} & … & {w}_{N 3}^{q} \\ ⋮ & ⋮ & ⋮ & ⋱ & ⋮ \\ {w}_{1 N}^{q} & {w}_{2 N}^{q} & {w}_{3 N}^{q} & … & {w}_{NN}^{q}\end{matrix} ]$$

where q=1, 2, 3, 4. FIG. 19B includes matrix equations 1914-1917 that represent the outputs of the hidden layers 1907-1910, respectively. Note that the FC stack 1902 is not limited to four hidden layers and the same number of nodes in each layer. The number of hidden layers and number of nodes in each of the hidden layers can be selected based on computation efficiency.

Returning to FIG. 19A, the output it [symbol] ₗ of the FC stack 1902 is input to a backward projection operator represented by block 1918 and a forward projection operator 1920. The backward projection operator 1918 performs a linear projection to obtain backward expansion coefficients given by:
where

θ^{b}=W^{b} [symbol] ₗ (6)
where

θ^{b}={θᵢ^{b}}ᵢ₌₁^{D}; and
D is the dimensionality of θ^{b}.
   The forward projection operator represented by block 1920 performs a linear projection to obtain forward expansion coefficients given by:

θ^{f}=W^{f} [symbol] ₗ (7)
where

θ^{f}={θᵢ^{f}}ᵢ₌₁^{d}; and
d is the dimensionality of θ^{f}.

In block 1922, the backward expansion coefficients θ^{b} are used to compute the backcast as follows:

$${\hat{x}}^{k} = {g}^{b} ( {θ}^{b} ) = {\sum }_{i = 1}^{D} {θ}_{i}^{b} {v}_{i}^{b} \qquad ( 8 )$$

where {vᵢ^{b}}₁₌₁^{D} are backcast basis vectors.

In block 1924, the forward expansion coefficients θ^{f} are used to compute the forecast as follows:

$${\hat{y}}^{k} = {g}^{f} ( {θ}^{f} ) = {\sum }_{i = 1}^{d} {θ}_{i}^{f} {v}_{i}^{f} \qquad ( 9 )$$

where {vᵢ^{f}}₁₌₁^{d} are forecast basis vectors.
   The functions g^{b} and g^{f} provide sets of basis vectors {vᵢ^{b}}₁₌₁^{D} and {vᵢ^{f}}₁₌₁^{d} such that respective outputs \hat{x}^{k} and ŷ^{k} are represented by the expansion coefficients θ^{b} and θ^{f}.

The weights of the FC stack 1902 are trained by partitioning historical metric data recorded in a historical time interval into train, validation, and test subsets. The validation and train subsets for each dataset are obtained by partitioning the full train sets at a boundary of the last horizon of each time series. For example, the historical metric [symbol] described above can partition into train, validation, and test subsets that are used to train weights of a fully connect DNN. The weights can be trained using machine learning in Tensorflow (See TensorFlow: Large-scale machine learning on heterogeneous systems, 2015. URL http://tensorflow.org/. Software available from tensorflow.org).

As described above with reference to FIG. 16, the forecast DNN 1616 outputs the forecast metric ŷ over the time interval [t_{N+1}, t_{N+H+1}]. The time interval can represent a runtime interval. When an actual metric value zₙ in the forecast time interval [t_{N+1}, t_{N+H+1}] is generated during runtime of the object, the metric value is scaled zₙ, as described above, to obtain the scaled actual metric value yₙ and a residual value between forecast metric value ŷₙ and the actual metric value is computed by

eₙ=|yₙ−ŷₙ| (10)

The residual value eₙ is computed for each runtime metric value generated in the time interval [t_{N+1}, t_{N+H+1}]. The residual value eₙ is recorded in data storage.

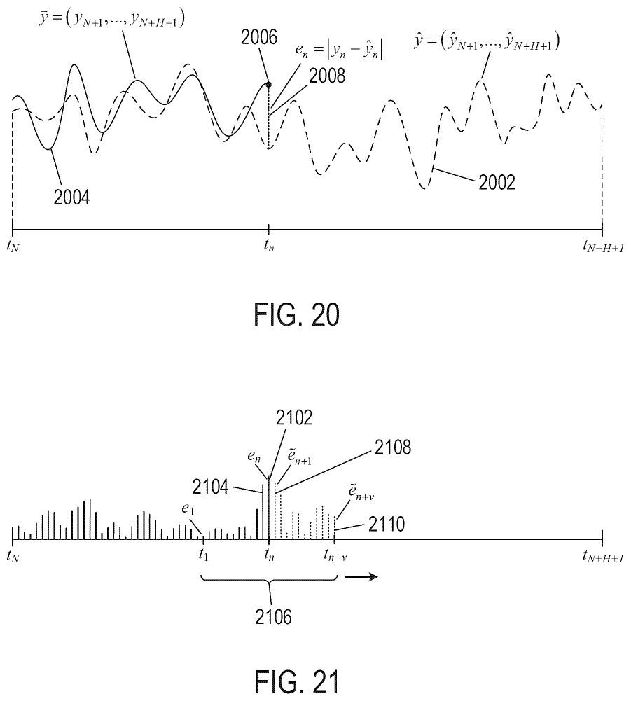

FIG. 20 shows a plot of the error between a forecast metric values and actual metric values in a time interval. Dashed curve 2002 represents the forecast metric ŷₙ output from the forecast DNN 1616 over the time interval [t_{N+1}, t_{N+H+1}]. Solid curve 2004 represents actual metric values [symbol] produced by the event source of the object in the time interval. Solid dot 2006 represents a current runtime metric value yₙ at the time stamp tₙ. Dotted line 2008 represents the residual eₙ between the runtime metric value yₙ and the forecast metric value ŷₙ.

SR anomaly detection computes saliency values and evaluates the saliency values as described below for anomalous behavior in real time. For example, a saliency value of a corresponding residual value can be computed in seconds so that anomalous behavior of the object is reported on a system console so that a system administrator is immediately made aware of the anomaly behavior and can respond with appropriate remedial measures. SR anomaly detection is run in a sliding window centered at the most recently computed runtime residual eₙ. The sliding window is formed from previously stored residual values e₀, . . . , eₙ₋₁ with corresponding time stamps that preceded the time stamp tₙ. Residual values do not exist for time stamps of the time interval [t_{N+1}, t_{N+H+1}] following tₙ. Estimated residual values are computed at time stamps later than tₙ in the sliding window:

$${\tilde{e}}_{n + 1} = {e}_{n - m + 1} + \overline{g} \cdot γ \\ where \\ \overline{g} = \frac{1}{γ} {\sum }_{i = 1}^{γ} g ( {e}_{n} , {e}_{n - i} ) \\ g ( {e}_{n} , {e}_{n - i} ) = \frac{{e}_{n} - {e}_{n - i}}{{t}_{n} - {t}_{n - i}} \qquad ( 11 )$$

The quantity g̅ is the average gradient of γ preceding residuals, where γ is a positive integer. The sequence of n residual values in the sliding window is denoted by [symbol] ₙ=(e₀, . . . , eₙ₋₁, eₙ, \tilde{e}ₙ₊₁, . . . \tilde{e}₂ₙ₋₁) Note that the sequence of residual values [symbol] ₙ is centered at the runtime residual value eₙ.

FIG. 21 shows a plot of residual values computed in the forecast time interval [t_{N+1}, t_{N+H+1}]. Solid vertical bars represent residual values as corresponding runtime metric values are generated according to Equation (10). For example, bar 2102 represents the magnitude of the residual value eₙ 2008 shown in FIG. 20. Vertical bar 2104 represents the magnitude of the residual value eₙ₋₁=|yₙ₋₁−ŷₙ| computed at preceding time stamp tₙ₋₁. Dotted vertical bars represent estimate residual values computed at time stamps later than the time stamp tₙ in the sliding window 2106. For example, dotted vertical bars 2108 and 2110 represent estimated residual values \tilde{e}ₙ₋₁ and \tilde{e}₂ₙ₋₁ the sliding window 2106.

A saliency map S of the metric values in the time interval is computed from the residuals in the time interval. The saliency map S reveals runtime actual metric values that are indicators of anomalous behavior of the event source. The saliency map consists of saliency values S(tₙ) computed for each runtime residual value eₙ at the time stamp tₙ in the sliding window 2106. The saliency map S is computed using SR anomaly detection, which includes Fourier transforming residuals to the frequency domain to obtain the log amplitude of the spectrum, (2) calculating a spectral residual from the log amplitude, and (3) inverse Fourier transforming the SR back to the time domain to obtain the saliency map. SR anomaly detection is executed as follows to obtain a saliency value S(tₙ) for a runtime residual value eₙ.

SR anomaly detection begins by transforming the sequence of residuals [symbol] ₙ from the time domain to the frequency domain using a Fourier transform:

$$E ( k ) = {\sum }_{i = 0}^{2 n - 1} {e}_{i} exp ( - j π ki / n ) \\ where \\ j = \sqrt{- 1} ; \\ {e}_{i} = {\tilde{e}}_{i} for i \geq n + 1 ; and \\ k = 0 , … , 2 n - 1. \qquad ( 12 )$$

Equation (12) transforms the 2n values of the sequence [symbol] ₙ into a sequence of 2n Fourier coefficients that form the spectrum of the residuals in the sliding window. The spectrum is denoted by (E(0), E(1), . . . , E (2n−1)). Each Fourier coefficient has a real and an imaginary part given by

E(k)=Re{E(k)}+iIm{E(k)} (13)
where
   Re{E(k)} is the real value of E(k); and
   Im{E(k)} is the imaginary value of E(k).
      The spectral residual technique performs the following operations on each Fourier coefficient of the spectrum. The amplitude spectrum of the Fourier coefficient E(k) is given by

A(k)={square root over ((R{E (k)})²+(Im{E (k)})²)} (14)

The phase spectrum of the Fourier coefficient E (k) is given by

$$P ( k ) = {tan}^{- 1} ( \frac{Im \{ E ( k ) \}}{Re \{ E ( k ) \}} ) \qquad ( 15 )$$

The log amplitude spectrum of the Fourier coefficient is given by

L(k)=log (A(k)) (16)

The average log spectrum is approximated from the log amplitude spectrum as follows:

$$AL ( k ) = \frac{1}{{( 2 n )}^{2}} {\sum }_{k = 0}^{2 n - 1} log ( A ( k ) ) \qquad ( 17 )$$

The SR spectrum is computed as follows:

R(k)=L(k)−AL (k) (18)

The SR spectrum (R(0), R(1), . . . , R(2n−1)) is a compressed representation of the spectrum (E(0), E(1), . . . , E(2n−1)). A complex exponential sequence (exp (R(0)+jP(0)), . . . , exp(R(2n−1)+jP (2n−1))) is formed from the SR spectrum and the phase spectrum. The complex exponential sequence is transformed back to the time domain using an inverse Fourier transform to obtain the saliency value for the residual eₙ:

$$S ( {t}_{n} ) = ‖ \frac{1}{2 n} {\sum }_{k = 0}^{2 n - 1} exp ( R ( k ) + jP ( k ) ) exp ( j π k ) ‖ \qquad ( 19 )$$

where ∥·∥ represents the norm.

Once the saliency value S(tₙ) of the runtime residual value eₙ is obtained, a corresponding anomaly score is computed as follows:

$$O ( {t}_{n} ) = \frac{S ( {t}_{n} ) - \overline{S} ( {t}_{n} )}{S ( {t}_{n} )} \\ where \\ \overline{S} ( {t}_{n} ) = \frac{1}{z} {\sum }_{i = n - z}^{n - 1} S ( {t}_{i} ) \qquad ( 20 )$$

The value S̅(tₙ) is the average of z previous saliency values in the saliency map. Each anomaly score is compared with an anomaly threshold, τ, to determine whether the corresponding actual runtime metric value yₙ is an indicator of abnormal behavior at the event source. When the following condition is satisfied

O(tₙ)>τ (21)

the corresponding runtime metric value yₙ is an indicator of anomalous behavior at the event source. An alert is generating in a display of a display device in response to detection of anomalous behavior. The alert identifies the metric, the runtime metric value that triggered the alert, the time stamp of the metric value, and the object.

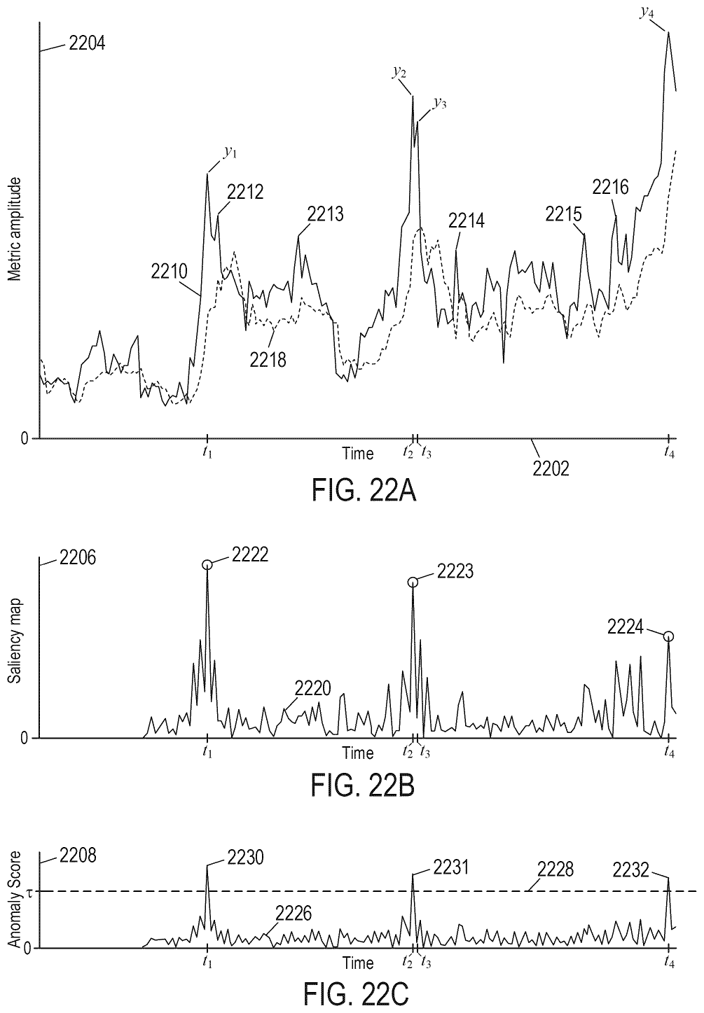

FIGS. 22A-22C show example plots of actual and forecast metric values of an event source, a corresponding saliency map, and anomaly scores over a forecast time interval. Horizontal axes, such as axis 2202, represent a forecast time interval. Vertical axis 2204 in FIG. 22A represents a range of metric amplitudes. Vertical axis 2206 in FIG. 22B represents a range of saliency values. Vertical axis 2208 in FIG. 22C represents a range anomaly scores. In FIG. 22A, jagged curve 2210 represents actual metric values produced by the event source during runtime in the forecast time interval. However, one cannot determine from simply viewing the actual metric values which metric values correspond to anomalous behavior at the event source. For example, actual metric values y₁, y₂, y₃, and y₄ recorded at corresponding time stamps t₁, t₂, t₃, and t₄ may be indicators of anomalous behavior. But other peaks in the curve 2210, such as peaks 2212-2216 may also be indicators of anomalous behavior. Dashed jagged curve 2218 represents forecast metric values produced by the forecast DNN 1616 described above for time stamps in the forecast time interval prior to generation of the actual metric values as described above. In FIG. 22B, jagged curve 2220 represents a saliency map of saliency values computed from the actual metric values and the forecast metric values in the forecast interval as described above with reference to Equations (10)-(18). The saliency map 2220 shows three distinct peaks 2222-2224 at corresponding time stamps t₁, t₂, and t₄ . In FIG. 22C, jagged curve 2226 represents anomaly scores computed from the saliency values as described above with reference to Equation (19). Dashed line 2228 corresponds to the threshold T. In this example, peaks 2230-2232 are anomaly scores that violate the threshold at corresponding time stamps t₁, t₂, and t₃, which confirms that the saliency values represented by peaks 2222-2224 correspond to anomalous actual metric values y₁, y₂, and y₄ represented in FIG. 22A.

When each of the actual metric values y₁, y₂, and y₄ are produced at runtime of the event source, an alert is generating in a display of a display device in response to detection of anomalous behavior with the corresponding anomaly scores. The alert identifies the metric, the runtime metric values y₁, y₂, and y₄ that triggered the alert, the time stamps of the metric values t₁, t₂, and t₄ , and the event source associated with the metric.

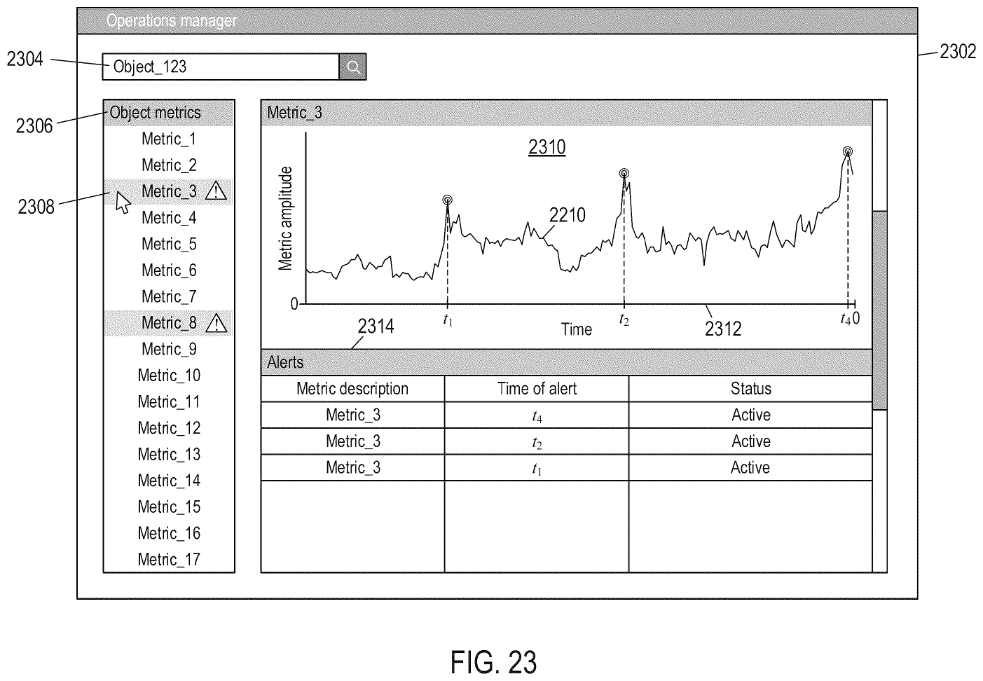

FIG. 23 shows an example graphical user interface (“GUI”) 2302 of an operations manager. The GUI 2302 includes a field 2304 for entering the name of an event source. In this example, the user has entered an object named “Object 123.” The object can be a VM, a server computer, a container, a pod of containers, an SDDC, a network device, or an application. The GUI 2302 includes a field 2306 that displays a list the various metrics associated with the named object. In this example, a metric Metric_3 and another metric Metric_8 are tagged with alert notifications. The metrics can, for example, represent different KPIs for the object “Object 123.” When a user clicks on the metric Metric_3 2308, a window 2310 displays most recent actual metric values of the metric Metric_3 2308 represented by jagged curve 2210 describe above with reference to FIG. 22A-22C. The window 2310 displays icons that identify runtime actual metric values associated with anomalous behavior of the Object_123 and the corresponding time stamps located along the time axis 2312. The GUI 2302 includes a table 2314 that list the metric name, time of each runtime alert, and the alert status, such as whether the alert is still active or the alert has been resolved.

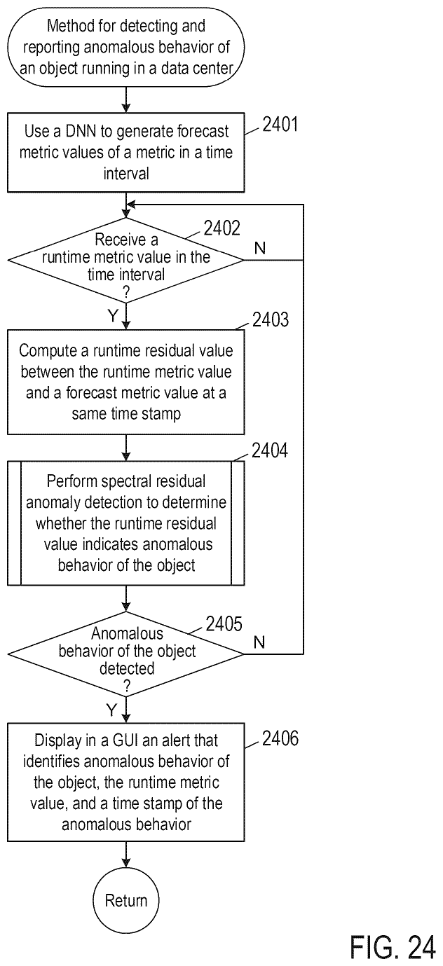

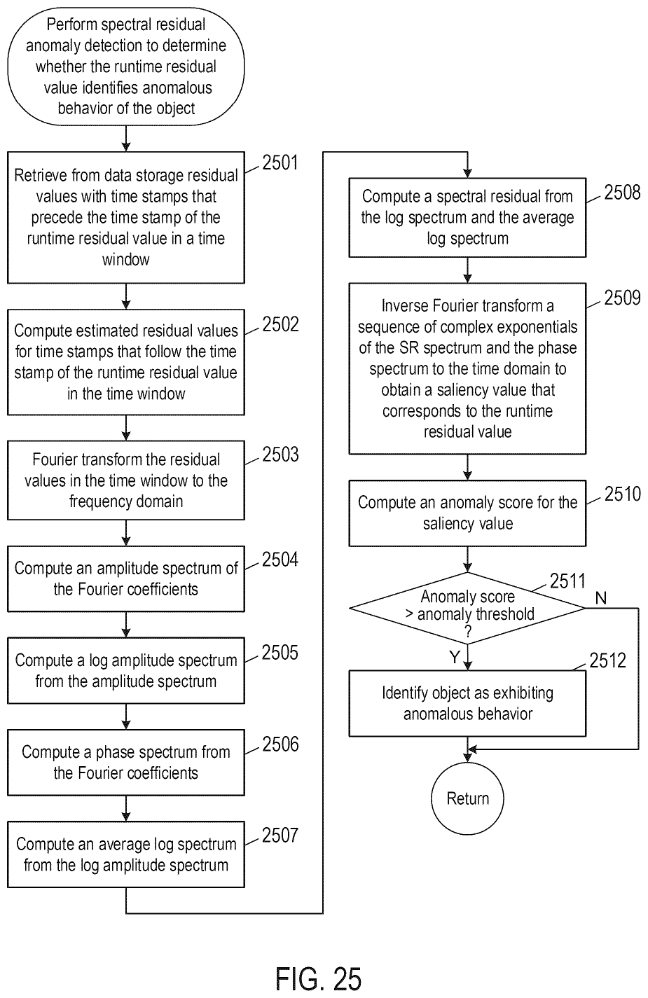

The methods described below with reference to FIGS. 24-25 are stored in one or more data storage devices as machine-readable instructions that when executed by the one or more processors of the computer system shown in FIG. 1.

FIG. 24 is a flow diagram of a method for detecting and reporting anomalous behavior of an object running in a data center. In block 2401, a DNN is used to generate forecast metric values of a metric of the object in a time interval as described above with reference to FIGS. 16-19B. In decision block 2402, when a runtime metric value of the metric received in the time interval, control flows to block 2403. In block 2403, a runtime residual value is computed between the runtime metric value and a forecast metric value at a same time stamp in the time interval as described above with reference to Equation (10). In block 2404, a “perform spectral residual anomaly detection to determine whether the runtime residual value indicates anomalous behavior or object” procedure is performed. An example implementation of the “perform spectral residual anomaly detection to determine whether the runtime residual value indicates anomalous behavior or object” procedure is described below with reference to FIG. 25. In decision block 2405, when anomalous behavior of the object is detected in block 2404, control flows to block 2406. In block 2406, an alert is displayed in a GUI on an electronic display device as described above with reference to FIG. 23. The alert identifies the anomalous behavior of the object, the runtime metric value, and a time stamp of the anomalous behavior.

FIG. 25 is a flow diagram illustrating an example implementation of the “perform spectral residual anomaly detection to determine whether the runtime residual value indicates anomalous behavior or object” procedure performed in block 2404 of FIG. 24. In block 2501, retrieve residual values with time stamps that precede the time stamp of the runtime residual value in a time window. In block 2502, compute estimated residual values for time stamps that follow the time stamp of the runtime residual in the time window as described above with reference to Equation (11). In block 2503, Fourier transform the residual values in the time window to the frequency domain as described above with reference to Equation (12). In block 2504, an amplitude spectrum of the Fourier coefficients are computed based on the residual values in the time window as described above with reference to Equation (12). In block 2505, compute a log spectrum of the amplitude spectrum as described above with reference to Equation (16). In block 2506, compute a phase spectrum from the Fourier coefficients as described above with reference to Equation (15). In block 2507, compute an average log spectrum from the log amplitude spectrum as described above with reference to Equation (17). In block 2508, compute a SR spectrum from the log spectrum and the average log spectrum as described above with reference to Equation (18). In block 2509, inverse Fourier transform is used to transform a complex exponential sequence of the SR spectrum and the phase spectrum to the time domain to obtain a saliency value that corresponds to the runtime residual value as described above with reference to Equation (19). In block 2510, an anomaly score is computed for the runtime residual value based on the saliency value as described above with reference to Equation (20). In decision block 2511, when the anomaly score is greater than the anomaly threshold as described above with reference to Equation (21), control flows to block 2512. In block 2512, the object is identified as exhibiting anomalous behavior.

It is appreciated that the previous description of the disclosed embodiments is provided to enable any person skilled in the art to make or use the present disclosure. Various modifications to these embodiments will be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

I/we claim:

1. A method stored in one or more data-storage devices and executed using one or more processors of a computer system for detecting and reporting anomalous behavior of an object running in a data center, the method comprising:
using a trained deep neural network (“DNN”) to generate forecast metric values of a metric of the object in a time interval from historical metric values of the metric;
for each runtime metric value of the metric generated in the time interval, computing a runtime residual value based on the runtime metric value and a forecast metric value at a time stamp in the time interval;
determining in real time whether the runtime residual value indicates anomalous behavior of the object using spectral residual anomaly detection; and
in response to detecting anomalous behavior of the object, displaying in a graphical user interface (“GUI”) of an electronic display device an alert that identifies anomalous behavior of the object, the runtime metric value, and a time stamp of the anomalous behavior.

2. The method of claim 1 wherein computing the residual value comprises:
computing the absolute difference between the runtime metric value and the forecast metric at the time; and
storing the residual values and associated time stamps in data storage.

3. The method of claim 1 wherein determining in real time whether the runtime residual value indicates anomalous behavior of the object comprises:
retrieving from data storage residual values with time stamps that precede the time stamp of the runtime residual value in a time window; and
computing estimated residual values for time stamps that follow the time stamp of the runtime residual value in the time window.

4. The method of claim 1 wherein determining in real time whether the runtime residual value indicates anomalous behavior of the object comprises:
Fourier transforming the residual values with time stamps in a time window from the time domain to obtain a sequence of Fourier coefficients in the frequency domain;
computing an amplitude spectrum of the Fourier coefficients;
computing a log amplitude spectrum from the amplitude spectrum;
computing a phase spectrum from the Fourier coefficients;
computing an average log spectrum from the log amplitude spectrum;
computing a spectral residual from the log spectrum and the average log spectrum; and
inverse Fourier transforming a complex exponential of the spectral residual and the phase from the frequency domain to the time domain to obtain a saliency value that corresponds to the residual value.

5. The method of claim 1 wherein determining in real time whether the runtime residual value indicates anomalous behavior of the object comprises:
computing an average saliency value from previously generated saliency values;
computing an anomaly score based on the average saliency value and the saliency value; and
identifying the object as exhibiting anomalous behavior when the anomaly score is greater than an anomaly threshold.

6. The method of claim 1 further comprises:
partitioning historical metric values of the metric into train, validation, and test subsets of historical metric values; and
training the trained DNN to generate forecast metric values in the time interval based on train, validation, and test subsets.

7. A computer system for detecting and reporting anomalous behavior of an object running in a data center, the computer system comprising:
one or more processors;
one or more data-storage devices; and
machine-readable instructions stored in the one or more data-storage devices that when executed using the one or more processors control the system to performance operations comprising:
using a trained deep neural network (“DNN”) to generate forecast metric values of a metric of the object in a time interval from historical metric values of the metric;
for each runtime metric value of the metric generated in the time interval, computing a runtime residual value based on the runtime metric value and a forecast metric value at a time stamp in the time interval;
determining in real time whether the runtime residual value indicates anomalous behavior of the object using spectral residual anomaly detection; and
in response to detecting anomalous behavior of the object, displaying in a graphical user interface (“GUI”) of an electronic display device an alert that identifies anomalous behavior of the object, the runtime metric value, and a time stamp of the anomalous behavior.

8. The computer system of claim 7 wherein computing the residual value comprises:
computing the absolute difference between the runtime metric value and the forecast metric at the time; and
storing the residual values and associated time stamps in data storage.

9. The computer system of claim 7 wherein determining in real time whether the runtime residual value indicates anomalous behavior of the object comprises:
retrieving from data storage residual values with time stamps that precede the time stamp of the runtime residual value in a time window; and
computing estimated residual values for time stamps that follow the time stamp of the runtime residual value in the time window.

10. The computer system of claim 7 wherein determining in real time whether the runtime residual value indicates anomalous behavior of the object comprises:
Fourier transforming the residual values with time stamps in a time window from the time domain to obtain a sequence of Fourier coefficients in the frequency domain;
computing an amplitude spectrum of the Fourier coefficients;
computing a log amplitude spectrum from the amplitude spectrum;
computing a phase spectrum from the Fourier coefficients;
computing an average log spectrum from the log amplitude spectrum;
computing a spectral residual from the log spectrum and the average log spectrum; and
inverse Fourier transforming a complex exponential of the spectral residual and the phase from the frequency domain to the time domain to obtain a saliency value that corresponds to the residual value.

11. The computer system of claim 7 wherein determining in real time whether the runtime residual value indicates anomalous behavior of the object comprises:
computing an average saliency value from previously generated saliency values;
computing an anomaly score based on the average saliency value and the saliency value; and
identifying the object as exhibiting anomalous behavior when the anomaly score is greater than an anomaly threshold.

12. The computer system of claim 7 further comprises:
partitioning historical metric values of the metric into train, validation, and test subsets of historical metric values; and
training the trained DNN to generate forecast metric values in the time interval based on train, validation, and test subsets.

13. A non-transitory computer-readable medium having instructions encoded thereon for enabling one or more processors of a computer system to detect and report anomalous behavior of an object running in a data center by performing operations comprising:
using a trained deep neural network (“DNN”) to generate forecast metric values of a metric of the object in a time interval from historical metric values of the metric;
for each runtime metric value of the metric generated in the time interval, computing a runtime residual value based on the runtime metric value and a forecast metric value at a time stamp in the time interval;
determining in real time whether the runtime residual value indicates anomalous behavior of the object using spectral residual anomaly detection; and
in response to detecting anomalous behavior of the object, displaying in a graphical user interface (“GUI”) of an electronic display device an alert that identifies anomalous behavior of the object, the runtime metric value, and a time stamp of the anomalous behavior.

14. The medium of claim 13 wherein computing the residual value comprises:
computing the absolute difference between the runtime metric value and the forecast metric at the time; and
storing the residual values and associated time stamps in data storage.

15. The medium of claim 13 wherein determining in real time whether the runtime residual value indicates anomalous behavior of the object comprises:
retrieving from data storage residual values with time stamps that precede the time stamp of the runtime residual value in a time window; and
computing estimated residual values for time stamps that follow the time stamp of the runtime residual value in the time window.

16. The medium of claim 13 wherein determining in real time whether the runtime residual value indicates anomalous behavior of the object comprises:
Fourier transforming the residual values with time stamps in a time window from the time domain to obtain a sequence of Fourier coefficients in the frequency domain;
computing an amplitude spectrum of the Fourier coefficients;
computing a log amplitude spectrum from the amplitude spectrum;
computing a phase spectrum from the Fourier coefficients;
computing an average log spectrum from the log amplitude spectrum;
computing a spectral residual from the log spectrum and the average log spectrum; and
inverse Fourier transforming a complex exponential of the spectral residual and the phase from the frequency domain to the time domain to obtain a saliency value that corresponds to the residual value.

17. The medium of claim 13 wherein determining in real time whether the runtime residual value indicates anomalous behavior of the object comprises:
computing an average saliency value from previously generated saliency values;
computing an anomaly score based on the average saliency value and the saliency value; and
identifying the object as exhibiting anomalous behavior when the anomaly score is greater than an anomaly threshold.

18. The medium of claim 13 further comprises:
partitioning historical metric values of the metric into train, validation, and test subsets of historical metric values; and
training the trained DNN to generate forecast metric values in the time interval based on train, validation, and test subsets.
